(19) United States
(12) Patent Application Publication
(10) Pub. No.: US 2011/0069036 A1
(43) Pub. Date: Mar. 24, 2011

(54) DISPLAY DEVICE

(75) Inventor: Kouichi ANNO, Mobara (JP)

(73) Assignee: Hitachi Displays, Ltd.

(21) Appl. No.: 12/883,557

(22) Filed: Sep. 16, 2010

(30) Foreign Application Priority Data
Sep. 18, 2009 (JP) 2009-216798

(51) Int. Cl. G06F 3/045

(52) U.S. Cl. 345/174

(57) ABSTRACT

In a display device including a capacitive coupling touch panel, reaction to touch with nonconductive input means is achieved, and highly accurate position detection is realized with a small number of electrodes even with a small touch area. X-electrodes and Y-electrodes which intersect with each other via a first insulating layer and a Z-electrode which is in a floating state via a second insulating layer are disposed. For the Z-electrode, a material whose thickness changes by pressing due to touch, such as an elastic conductive material, is used. The Z-electrode is arranged so as to overlap both the X-electrode and the Y-electrode neighboring to each other. A pad portion of the X-electrode has a shape such that an area is maximized in the vicinity of a fine line portion of the relevant X-electrode.

### CROSS-REFERENCE TO RELATED APPLICATION

The present application claims priority from Japanese application JP 2009-216798 filed on Sep. 18, 2009, the content of which is hereby incorporated by reference into this application.

### BACKGROUND OF THE INVENTION

1. Field of the Invention

The present invention relates to an input device which inputs coordinates by touching a screen and a display device including the input device, and in particular, the invention is suitable for increasing coordinate detection accuracy in a display device having a capacitive touch panel.

2. Description of the Related Art

Display devices including a device (hereinafter also referred to as a touch sensor or a touch panel) which inputs information by a touch operation (contacting and pressing operation; hereinafter simply referred to as touch) on a display screen using a user's finger, a pen, or the like are used for mobile electronic apparatuses such as PDAs or portable terminals, various household electrical appliances, and automated teller machines. As such a touch panel, a resistive film system which detects a change in the resistance value of a touched portion, a capacitive system which detects a capacitance change, an optical sensor system which detects a change in the amount of light, and the like have been known.

The capacitive system has the following advantages when compared to the resistive film system or the optical sensor system. For example, the resistive film system or the optical sensor system has a low transmittance ratio of around 80%, whereas the capacitive system has a high transmittance ratio of about 90%. Therefore, it has an advantage in not decreasing display quality. Moreover, the resistive film system has a risk of degrading or damaging a resistive film because a touch position is detected by a mechanical contact of the resistive film, whereas the capacitive system has no mechanical contact such as a contact of a detecting electrode with another electrode. Therefore, it has another advantage in terms of durability.

As a capacitive touch panel, for example, there is such a system as disclosed in U.S. Pat. No. 7,030,860. In the disclosed system, detecting electrodes (X-electrodes) in the vertical direction and detecting electrodes (Y-electrodes) in the horizontal direction arranged in a vertical and horizontal, two-dimensional matrix are disposed, and the capacitance of each of the electrodes is detected by an input processing unit. When a conductor such as a finger contacts the surface of the touch panel, the capacitance of each of the electrodes increases. Therefore, the increase is detected by the input processing unit, and input coordinates are calculated based on a signal of the capacitance change detected in each of the electrodes.

### SUMMARY OF THE INVENTION

However, since the capacitive touch panel detects input coordinates by detecting the capacitance change of each of the detecting electrodes as disclosed in U.S. Pat. No. 7,030,860, a material is used as input means on the premise that it has conductivity. Therefore, when a resin-made stylus or the like having no conductivity used in the resistive film system and the like is brought into contact with the capacitive touch panel, the capacitance change of the electrode hardly occurs, and therefore, a problem results in that input coordinates cannot be detected.

Moreover, in the use of the capacitive touch panel where a resin-made stylus or the like contacts simultaneously at two points, since two X-coordinates and two Y-coordinates are detected, four coordinates are conceivable as potential contact points, which makes it difficult to detect the simultaneously contacted two points. Further, when coping with input means with a small contact surface, there is a need for a method of detecting coordinates with good accuracy without increasing the number of electrodes.

The invention has been made for solving the problems in the related art, and it is an object of the invention to provide a technique which enables, in a display device including a capacitive coupling touch panel, reaction to touch with nonconductive input means, realization of highly accurate position detection with a small number of electrodes even with a small touch area, and detection of coordinates with good accuracy when contacted simultaneously at two points.

The above and other objects, and novel features of the invention will become apparent from the description in the specification and the accompanying drawings.

### BRIEF DESCRIPTION OF THE DRAWINGS

FIG. 1 is a schematic configuration view of a display device including an input device according to an embodiment of the invention.

FIG. 2 is a schematic plan view of electrodes of the display device including the input device according to the embodiment of the invention.

FIG. 3 is a schematic cross-sectional view of the electrodes of the display device including the input device according to the embodiment of the invention.

FIG. 4 is a schematic circuit diagram of the electrodes of the display device including the input device according to the embodiment of the invention.

FIG. 5 is a schematic cross-sectional view of an electrode portion of the input device according to the embodiment of the invention.

FIG. 6 is a schematic cross-sectional view of the electrode portion of the input device according to the embodiment of the invention.

FIG. 7 is a schematic plan view showing detected intensities of the electrode portion of the input device according to the embodiment of the invention.

FIG. 8 is a schematic cross-sectional view of an electrode portion of the input device according to the embodiment of the invention.

FIG. 9 is a schematic cross-sectional view of an electrode portion of the input device according to the embodiment of the invention.

FIG. 10 is a schematic cross-sectional view of an electrode portion of the input device according to the embodiment of the invention.

FIG. 11 is a schematic cross-sectional view of an electrode portion of the input device according to the embodiment of the invention.

FIG. 12 is a schematic cross-sectional view of an electrode portion of the input device according to the embodiment of the invention.

FIG. 13 is a schematic cross-sectional view of an electrode portion of the input device according to the embodiment of the invention.

FIG. 14 is a schematic plan view showing detected intensities of the electrode portion of the input device according to the embodiment of the invention.

FIG. 15 is a schematic cross-sectional view showing a method for manufacturing an electrode portion of the input device according to the embodiment of the invention.

FIG. 16 is a schematic cross-sectional view showing the method for manufacturing the electrode portion of the input device according to the embodiment of the invention.

FIG. 17 is a schematic configuration view showing a method for manufacturing a sealing material of the input device according to the embodiment of the invention.

FIG. 18 is a schematic plan view showing a screen plate of the sealing material of the input device according to the embodiment of the invention.

FIG. 19 is a schematic plan view showing the sealing material of the input device according to the embodiment of the invention.

FIG. 20 is a schematic cross-sectional view showing a method for manufacturing the input device according to the embodiment of the invention.

FIG. 21 is a schematic plan view of an electrode portion of the input device according to the embodiment of the invention.

FIG. 22 is a schematic plan view of an electrode portion of the input device according to the embodiment of the invention.

FIG. 23 is a schematic plan view showing detected intensities of an electrode portion of the input device according to the embodiment of the invention.

FIG. 24 is a schematic plan view showing detected intensities of an electrode portion of the input device according to the embodiment of the invention.

FIG. 25 is a schematic plan view showing detected intensities of an electrode portion of the input device according to the embodiment of the invention.

FIG. 26 is a schematic circuit diagram showing a detection circuit of the input device according to the embodiment of the invention.

FIG. 27 is a schematic circuit diagram of the detection circuit of the input device according to the embodiment of the invention.

FIG. 28 is a timing diagram showing operation of the detection circuit of the input device according to the embodiment of the invention.

FIG. 29 is a schematic view showing the operation of the detection circuit of the input device according to the embodiment of the invention.

FIG. 30 is a schematic view showing the operation of the detection circuit of the input device according to the embodiment of the invention.

FIG. 31 is a schematic plan view of the input device according to the embodiment of the invention.

FIG. 32 is a schematic plan view of the input device according to the embodiment of the invention.

FIG. 33 is a schematic cross-sectional view showing a method for manufacturing the input device according to the embodiment of the invention.

FIG. 34 is a schematic cross-sectional view showing the method for manufacturing the input device according to the embodiment of the invention.

FIG. 35 is a schematic cross-sectional view showing the method for manufacturing the input device according to the embodiment of the invention.

FIG. 36 is a schematic cross-sectional view showing the method for manufacturing the input device according to the embodiment of the invention.

FIG. 37 is a schematic cross-sectional view showing the method for manufacturing the input device according to the embodiment of the invention.

FIG. 38 is a schematic cross-sectional view showing the method for manufacturing the input device according to the embodiment of the invention.

FIG. 39 is a schematic cross-sectional view showing the method for manufacturing the input device according to the embodiment of the invention.

FIG. 40 is a schematic cross-sectional view showing the method for manufacturing the input device according to the embodiment of the invention.

FIG. 41 is a schematic cross-sectional view showing the method for manufacturing the input device according to the embodiment of the invention.

FIG. 42 is a schematic cross-sectional view showing the method for manufacturing the input device according to the embodiment of the invention.

FIG. 43 is a schematic cross-sectional view showing the method for manufacturing the input device according to the embodiment of the invention.

FIG. 44 is a schematic cross-sectional view showing the method for manufacturing the input device according to the embodiment of the invention.

FIG. 45 is a schematic plan view of an input device according to a modified example of the embodiment of the invention.

FIG. 46 is a schematic cross-sectional view showing a method for manufacturing the input device according to the modified example of the embodiment of the invention.

FIG. 47 is a schematic cross-sectional view showing the method for manufacturing the input device according to the modified example of the embodiment of the invention.

FIG. 48 is a schematic cross-sectional view showing the method for manufacturing the input device according to the modified example of the embodiment of the invention.

FIG. 49 is a schematic cross-sectional view showing the method for manufacturing the input device according to the modified example of the embodiment of the invention.

FIG. 50 is a schematic cross-sectional view showing the method for manufacturing the input device according to the modified example of the embodiment of the invention.

FIG. 51 is a schematic cross-sectional view showing the method for manufacturing the input device according to the modified example of the embodiment of the invention.

FIG. 52 is a schematic cross-sectional view showing an input device according to a modified example of the embodiment of the invention.

FIG. 53 is a schematic plan view showing a liquid crystal display device including the input device according to the embodiment of the invention.

FIG. 54 is a schematic cross-sectional view showing the liquid crystal display device including the input device according to the embodiment of the invention.

FIG. 55 is a schematic plan view showing a liquid crystal display panel according to the embodiment of the invention.

FIG. 56 is a schematic perspective view showing a front face panel according to the embodiment of the invention.

FIG. 57 is a schematic plan view showing the input device according to the embodiment of the invention.

FIG. 58 is a schematic cross-sectional view showing the input device according to the embodiment of the invention.

FIG. 59 is a schematic plan view showing the input device according to the embodiment of the invention.

FIG. 60 is a schematic cross-sectional view showing a liquid crystal display device including the input device according to the embodiment of the invention.

### DETAILED DESCRIPTION OF THE INVENTION

A typical outline of the invention disclosed herein will be briefly described below.

In the invention, for solving the above problems, a capacitive touch panel including a plurality of X-electrodes, a plurality of Y-electrodes, and a Z-electrode overlapping both the X-electrode and the Y-electrode is used. In the capacitive touch panel, the X-electrode and the Y-electrode intersect with each other via a first insulating layer; each of the X-electrode and the Y-electrode is formed such that pad portions and fine line portions are alternately arranged in its extending direction; and the pad portion of the X-electrode and the pad portion of the Y-electrode are arranged so as not to overlap each other as viewed in plan.

The Z-electrode is formed so as to overlap, via a second insulating layer, both the X-electrode and the Y-electrode neighboring to each other as viewed in plan. A spacer is disposed between the Z-electrode, and the X-electrode and the Y-electrode, and the Z-electrode is arranged with a constant gap relative to both the X-electrode and the Y-electrode. The Z-electrode is formed of a flexible conductive layer, and a transparent elastic layer is stacked on the Z-electrode. The Z-electrode and the transparent elastic layer elastically deform by touch, so that the gap between both the X-electrode and the Y-electrode and the Z-electrode changes. Therefore, the combined capacitance value between the X-electrode and the Y-electrode can be changed via the Z-electrode.

Further, in the vicinity of the spacer, the Z-electrode and the transparent elastic layer sag around the spacer by pressing, so that the gap between both the X-electrode and the Y-electrode and the Z-electrode changes.

The pad portion of the X-electrode extends to the vicinity of a fine line portion of an X-electrode neighboring to the relevant X-electrode. As viewed in plan, the relevant X-electrode has a shape in the pad portion such that an area is minimized in the vicinity of the fine line portion of the neighboring X-electrode and maximized in the vicinity of the fine line portion of the relevant X-electrode, and that the area of the relevant pad portion decreases from the vicinity of the fine line portion of the relevant X-electrode toward the vicinity of the fine line portion of the neighboring X-electrode. Thus, even when the electrode gap of the X-electrodes is wide compared to a contact surface in the touch operation, the touch coordinate position can be calculated based on the ratio of detected capacitive components of the X-electrodes neighboring to each other, which enables highly accurate position detection with a small number of electrodes. Moreover, one of the X-electrode and the Y-electrode are sequentially applied with a signal, and a change in the signal is detected in the other electrode, so that it is previously determined to which of the electrodes the signal has been applied, making it possible to improve detection accuracy when contacted simultaneously at two points in the capacitive touch panel.

A typical advantage obtained by the invention disclosed herein will be briefly described below.

According to the embodiment of the invention, in a display device including a capacitive coupling touch panel, it is possible to react to touch with nonconductive input means, to realize highly accurate position detection with a small number of electrodes even with a small touch area, and to detect coordinates with good accuracy even when contacted simultaneously at two points.

Hereinafter, an embodiment of the invention will be described in detail with reference to the drawings.

Throughout the drawings for describing the embodiment, constituents having the same function are denoted by the same reference numeral and sign, and the repetitive description thereof is omitted.

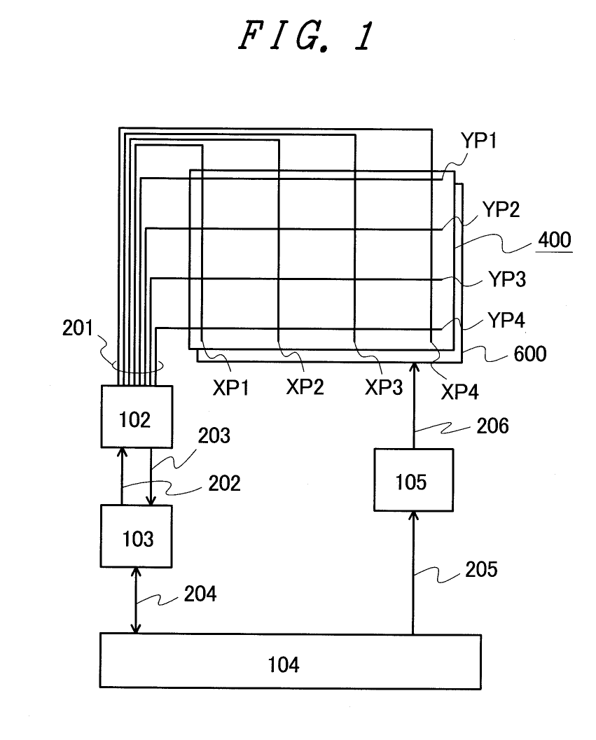

FIG. 1 shows the configuration of an input device (touch panel) of the embodiment of the invention and a display device including the input device. In FIG. 1, reference numeral 400 denotes the touch panel of the embodiment. The touch panel 400 has X-electrodes XP and Y-electrodes YP both for capacitance detection. In this case for example, four X-electrodes (from XP1 to XP4) and four Y-electrodes (from YP1 to YP4) are illustrated, but the number of electrodes is not limited to this.

The touch panel 400 is disposed at the front of the display device 600. Accordingly, when a user sees an image displayed on the display device 600, the display image needs to transmit through the touch panel 400. Therefore, the touch panel 400 has desirably high light transmittance ratio.

The X-electrodes and Y-electrodes of the touch panel 400 are connected to a capacitance detecting unit 102 with detecting wiring lines 201. The capacitance detecting unit 102 is controlled by a detection control signal 202 output from a control operation unit 103, detects the capacitance of each of the electrodes (X-electrodes and Y-electrodes) included in the touch panel, and outputs a capacitance detection signal 203 which changes depending on the capacitance value of each of the electrodes to the control operation unit 103.

The control operation unit 103 calculates the signal component of each of the electrodes based on the capacitance detection signal 203 of each of the electrodes and obtains input coordinates by carrying out an operation based on the signal component of each of the electrodes. The control operation unit 103 transfers the input coordinates to a system control unit 104 using an I/F signal 204.

When the input coordinates are transferred from the touch panel 400 by touch operation, the system control unit 104 generates a display image according to the touch operation and transfers the display image to a display control circuit 105 as a display control signal 205.

The display control circuit 105 generates a display signal 206 according to the display image transferred by the display control signal 205 and displays the image on the display device 600.

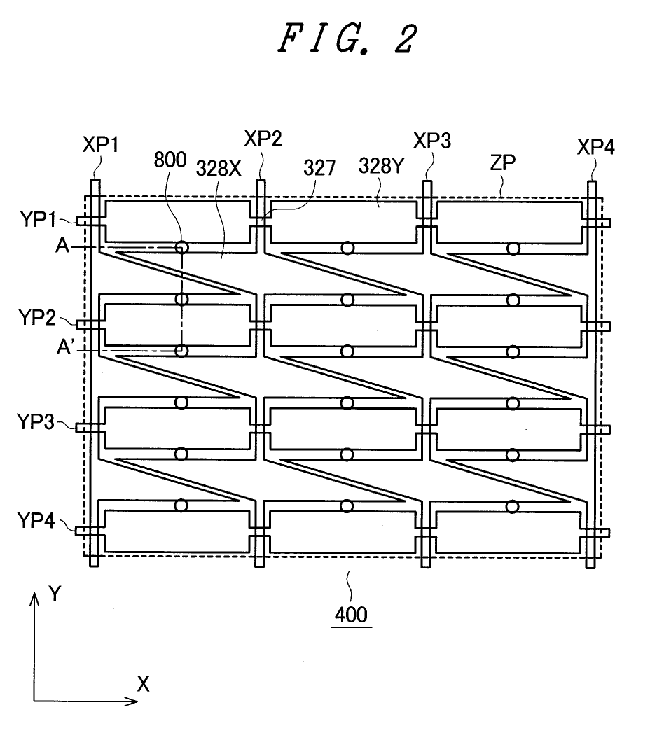

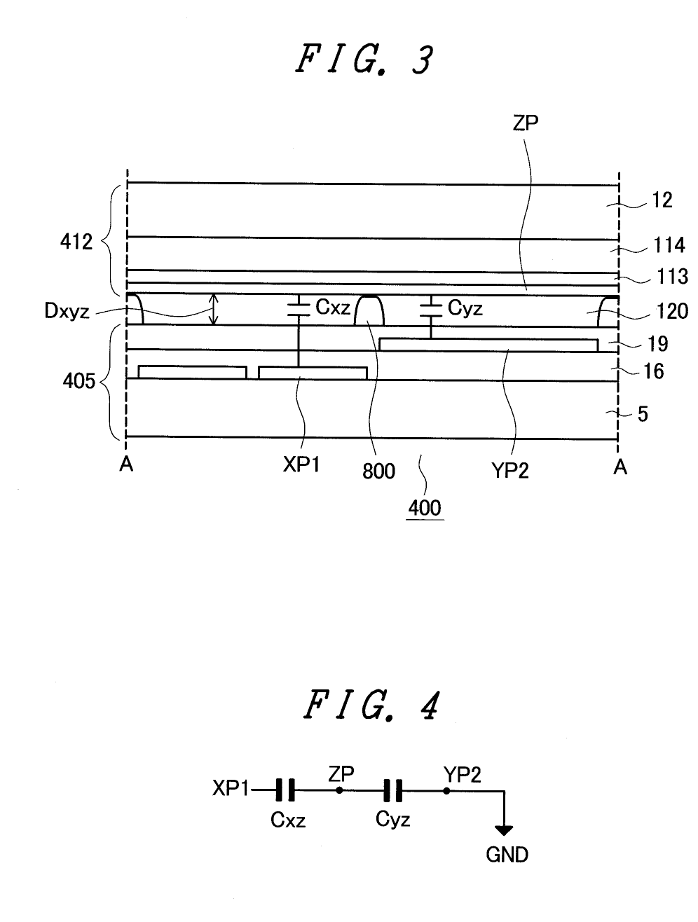

Next, the electrodes for capacitance detection disposed in the touch panel 400 of the embodiment will be described with reference to FIGS. 2 and 3.

FIG. 2 is a diagram showing the electrode pattern of the X-electrodes XP and Y-electrodes YP for capacitance detection and a Z-electrode ZP of the touch panel 400. For example, the X-electrodes XP are connected to the capacitance detecting unit 102 with the detecting wiring lines 201. On the other hand, a pulse signal at a predetermined timing with a predetermined voltage is applied to the Y-electrode YP with the detecting wiring lines 201 in a fixed period. The Z-electrode ZP is not electrically connected and in a floating state.

As shown in FIG. 2, the Y-electrode YP extends in the horizontal direction (X-direction in the drawing) of the touch panel 400, and the plurality of Y-electrodes YP are arranged in the vertical direction (Y-direction in the drawing). At an intersecting portion of the Y-electrode YP and the X-electrode XP, the electrode width of each of the Y-electrode YP and the X-electrode XP is reduced for decreasing the intersection capacitance of the electrodes. This portion is called a fine line portion 327. Accordingly, the Y-electrode YP has a shape such that the fine line portions 327 and electrode portions (hereinafter called pad portions or individual electrodes) 328Y each interposed between the fine line portions 327 are alternately arranged in its extending direction.

The X-electrode XP is arranged between the Y-electrodes YP neighboring to each other. The X-electrode XP extends in the vertical direction of the touch panel 400, and the plurality of X-electrodes XP are arranged in the horizontal direction. Similarly to the Y-electrode YP, the X-electrode XP has a shape such that the fine line portions 327 and pad portions 328X are alternately arranged in its extending direction.

As shown in FIG. 2, the pad portion 328X of the X-electrode XP has a diamond shape. For describing the shape of the pad portion 328X of the X-electrode XP, it is assumed that the wiring position (or the fine line portion 327 of the X-electrode XP) for connecting the X-electrode XP to the detecting wiring line is the center of the X-electrode XP in the horizontal direction. The pad portion 328X of the X-electrode XP has an electrode shape such that an area decreases as the pad portion approaches the center of another X-electrode XP neighboring thereto and that the area increases closer to the center of the relevant X-electrode XP.

Therefore, when considering the area of the X-electrode XP between two neighboring X-electrodes XP, for example, between the X-electrodes XP1 and XP2, the electrode area (electrode width) of the pad portion 328X of the X-electrode XP1 is maximized in the vicinity of the center of the X-electrode XP1, and the electrode area (electrode width) of the pad portion 328X of the X-electrode XP2 is minimized. On the other hand, the electrode area (electrode width) of the pad portion 328X of the X-electrode XP1 is minimized in the vicinity of the center of the X-electrode XP2, and the electrode area (electrode width) of the pad portion 328X of the X-electrode XP2 is maximized. In this case, the shape of the pad portion 328X between the two neighboring X-electrodes XP has a feature in that the shape is convex toward the neighboring X-electrode XP.

In FIG. 2, although the X-electrode XP is convex toward the right and left sides, the shape of the X-electrode XP is not limited to this. For example, the electrode shape on the left side of the pad portion 328X of the X-electrode XP may be convex, and the electrode shape on the right side may be concave; the electrode shape on the right side of the X-electrode XP may be convex, and the electrode shape on the left side may be concave; and the electrode shape of the X-electrode XP may be convex on the right and left sides, and the electrode shape of the neighboring X-electrode XP may be concave. The Z-electrode ZP is arranged so as to overlap the Y-electrode YP and the X-electrode XP.

In FIG. 2, the Z-electrode ZP and spacers 800 are shown. The spacers 800 are formed for maintaining the gap between the X-electrode XP and the Y-electrode YP, and the Z-electrode ZP. The Z-electrode ZP and the spacer 800 will be described in detail later.

FIG. 3 is a schematic cross-sectional view showing a cross sectional structure along the cutting line A-A′ of FIG. 2. In FIG. 2 and the cross-sectional view shown in FIG. 3, only layers necessary for describing touch panel operation are shown.

In a capacitive touch panel, a change in capacitance value generated between the X-electrode XP and the Y-electrode YP is detected, and conventionally, an XY-electrode substrate 405 on the lower side of the drawing suffices. In the embodiment, however, a Z-electrode substrate 412 on the upper side of the drawing is newly disposed for improving the detection accuracy in the touch panel 400.

The electrodes of the XY-electrode substrate 405 of the touch panel 400 are formed on a first transparent substrate 5. The X-electrodes XP are first formed at portions closer to the first transparent substrate 5, and a first insulating film 16 for insulation between the X-electrode and the Y-electrode is next formed. Next, the Y-electrodes YP are formed. In this case, the order of the X-electrode XP and the Y-electrode may be reversed. A second insulating film 19 is formed on the Y-electrodes YP so as to cover the Y-electrodes YP and the first insulating film 16.

As described above, the spacers 800 are disposed between the XY-electrode substrate 405 and the Z-electrode substrate 412 to maintain the gap between the XY-electrode substrate 405 and the Z-electrode substrate 412. At the vicinity of the peripheries of the substrates, a sealing material (not shown) is disposed in a frame shape to fix the XY-electrode substrate 405 with the Z-electrode substrate 412. Moreover, a sensing insulating layer 120 is disposed between the XY-electrode substrate 405 and the Z-electrode substrate 412.

Next, in the Z-electrode substrate 412, from the upper side of the drawing, a transparent elastic layer 114 formed of an acrylic resin is disposed on a second transparent substrate 12, and further, a supporting layer 113 formed of an acrylic adhesive and the Z-electrode ZP are disposed. The rigidity of the transparent elastic layer 114 is lower than that of the second transparent substrate 12. The materials constituting the transparent elastic layer 114 and the supporting layer 113 are not limited to the above-described materials.

It suffices that the sensing insulating layer 120 between the XY-electrode substrate 405 and the Z-electrode substrate 412 be a transparent insulating material whose thickness changes when pressed by a touch operation. For example, the sensing insulating layer 120 may be formed using an elastic insulating material or the like. For the sensing insulating layer 120, a gas whose volume changes by pressure, such as air, is preferably used. In a case of using a gas, the spacers 800 need to be arranged between the Z-electrode ZP, and the X-electrode XP and the Y-electrode YP for maintaining the thickness of the sensing insulating layer 120 constant during no contact.

As the Z-electrode ZP for example, an organic conductive material such as a polythiophene-based organic conductive material, sulfonated polyanine, or polypyrrole, or a synthetic resin containing conductive fine particles (for example, ITO fine particles) dispersed therein can be used. Similarly, a flexible synthetic resin or the like can be used for the transparent elastic layer 114 and the supporting layer 113.

In the embodiment, since the spacers 800 are disposed between the Z-electrode ZP, and the X-electrode XP and the Y-electrode YP, the numerous spacers 800 are scattered within a display screen. Forming the spacer 800 with a transparent or light-colored material causes light condensing or light scattering at the spacer 800 and in the vicinity thereof, thereby leading to a secondary problem of decreasing display quality.

In the embodiment, therefore, a black material or a deep colored material in the blue color family (with an optical density (OD value) of at least 2 or more, preferably 3 or more) is used as the material of the spacer 800, so that the secondary problem is solved. The optical density (OD value) is a value obtained by the formula: CD=log(1/T) where T(%) is the transmittance ratio.

As the spacer 800 for example, a pigment-dispersed acrylic resin is used, and in addition, an acrylic resin such as a color resist film is used. In a case of using a conductive material as the material of the spacer 800, an insulating (resistance increasing) process must be applied by coating or the like.

Next, a capacitance change at the time of touch operation in the touch panel 400 will be described. As shown in FIG. 3, a capacitance Cxz and a capacitance Cyz are formed between the X-electrode XP and the Y-electrode YP via the Z-electrode ZP. For example, when a signal is supplied from the X-electrode XP; the Y-electrode YP is connected to the ground potential; and the Z-electrode ZP is brought into the floating state, the connection state between the capacitance Cxz and the capacitance Cyz can be represented by a circuit diagram shown in FIG. 4.

In the circuit shown in FIG. 4, a combined capacitance Cxy of the capacitance Cxz and the capacitance Cyz is expressed as: Cxy=Cxz×Cyz/(Cxz+Cyz). When the distance between the X-electrode XP and the Z-electrode ZP is changed by touch, and similarly, the distance between the Y-electrode YP and the Z-electrode ZP is changed, the value of the combined capacitance Cxy is also changed.

Hereinafter, assuming that a change in the thicknesses of the first insulating film 16 and the second insulating film 19 by touch can be ignored, the distance of the Z-electrode ZP relative to the X-electrode XP and the Y-electrode YP, which changes the value of the capacitance Cxy, is denoted by a gap Dxyz. The distance between the X-electrode XP and the Z-electrode ZP and the distance between the Y-electrode YP and the Z-electrode ZP are actually different from the gap Dxyz. However, since it is conceivable that the capacitance Cxy changes according to a change in the thickness of the sensing insulating layer 120, the description will be made using the gap Dxyz for simplicity. Although the gap Dxyz is the thickness of the sensing insulating layer 120, it can be expressed as the distance between the Z-electrode ZP and the second insulating film 19.

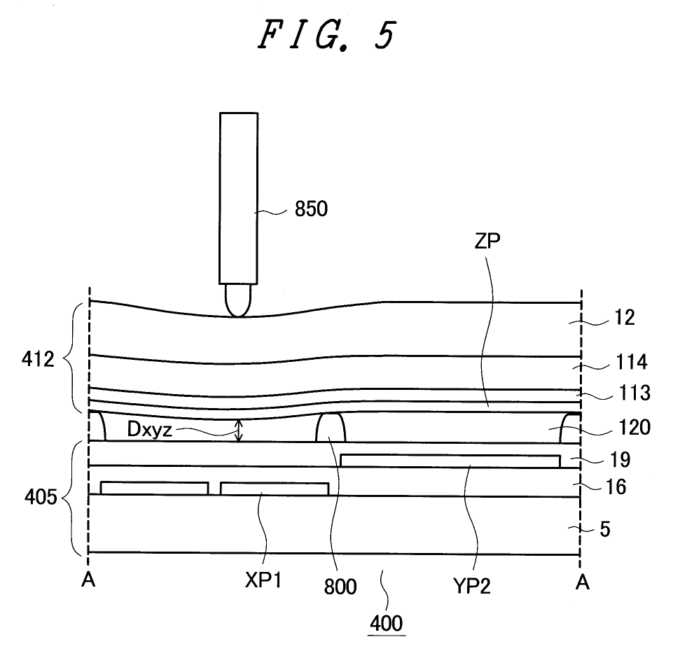

Next, FIG. 5 shows a state where touch is made with a nonconductive pen 850 or the like. When the nonconductive pen 850 is used, a capacitance change caused by the contact of the nonconductive pen 850 with the touch panel 400 is very tiny because no current flows through the nonconductive pen 850. Therefore, when the nonconductive pen 850 is used, detecting a capacitance change is difficult in a conventional capacitive touch panel.

Therefore, the Z-electrode ZP is used for detecting touch with the nonconductive pen 850. However, in a case where the spacer 800 and the Z-electrode ZP are hard, and the spacer 800 and the Z-electrode ZP do not deform even when pressed with the pen 850, the Z-electrode ZP is pushed back by the spacer 800, so that the gap Dxyz changes only slightly. Therefore, the change in the combined capacitance Cxy is also tiny, which makes it difficult to detect a capacitance change.

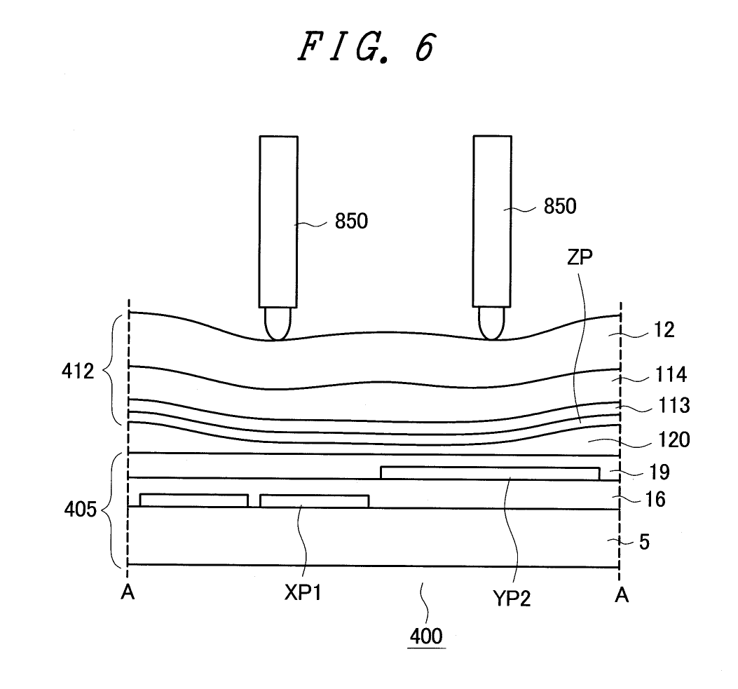

Next, FIG. 6 shows a case where the spacer 800 is not disposed for avoiding the restriction by the spacer 800. In this case, since pushing back is not caused by the spacer 800, the amount of change in the gap Dxyz is dominated by a member having high rigidity. Since the second transparent substrate 12 is generally high in rigidity, the position of the Z-electrode ZP is changed according to the amount of bending of the second transparent substrate 12 pressed by the nonconductive pen 850.

As shown in FIG. 6 in this case, however, when two points close to each other are pressed, a problem results in that it is difficult to separately detect the two points. As described above, the change caused by pressing with the pen 850 is similar to the change in the second transparent substrate 12 having high rigidity. Therefore, when the distance between two points pressed simultaneously is short relative to the distance from the point at which the second transparent substrate 12 is fixed (the position of the sealing material), it is difficult to detect the amount of change between the two points because the amount of bending with the fixed point as a fulcrum point is large compared to the amount of bending between the two points.

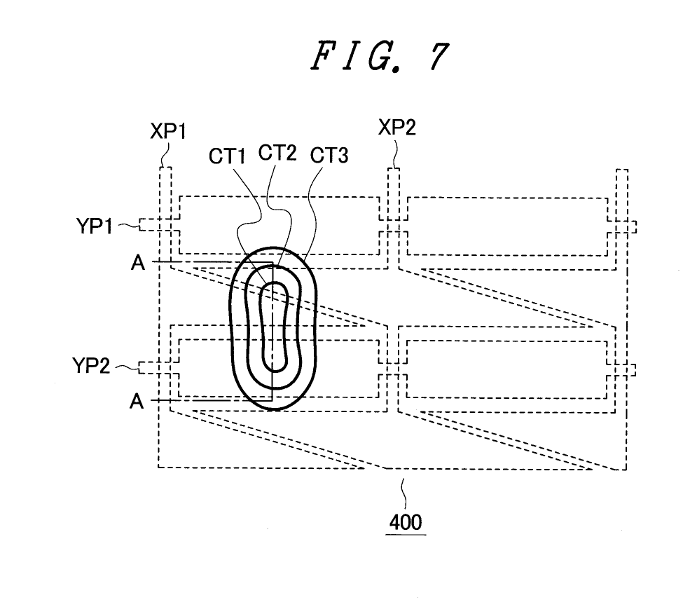

FIG. 7 shows the detected intensities of the capacitance Cxy when two points close to each other are pressed. In FIG. 7, the detected intensities are shown by lines CT1 to CT3 each of which is obtained by connecting points having the same detected intensity. As shown in FIG. 7, the lines CT1 to CT3 are each continuous between the two points, and it is difficult to separately detect the two points based on the capacitance change.

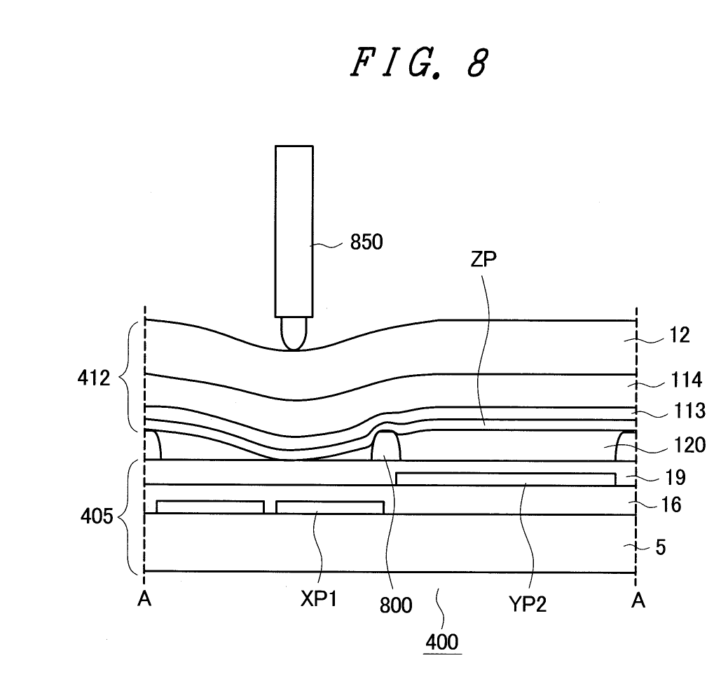

Next, FIG. 8 shows a case where the Z-electrode ZP is formed of an elastically deformable, flexible material such as an organic conductive film. The transparent elastic layer 114 and the supporting layer 113 stacked on the Z-electrode ZP are also formed of a flexible material. The second transparent substrate 12 is bent when touched with the nonconductive pen 850, and along with the bending, the Z-electrode ZP moves so as to narrow the gap Dxyz.

When the Z-electrode ZP abuts on the spacer 800, the Z-electrode ZP elastically deforms because the Z-electrode ZP is softer than the spacer 800. Therefore, the displacement of the Z-electrode ZP is not limited by the spacer 800, and the gap Dxyz is narrowed to such an extent that the amount of change in the capacitance Cxy can be detected. Further, since both the transparent elastic layer 114 and the supporting layer 113 are also formed of a flexible material, the spacer 800 is brought into such a state that it is buried into the Z-electrode ZP, which easily narrows the gap Dxyz.

The state where the Z-electrode ZP elastically deforms in this case means that not only the Z-electrode ZP but also the transparent elastic layer 114 and the supporting layer 113 both stacked thereon deform to such an extent that the amount of change in the capacitance Cxy can be detected. That is, it means the state where any of the thicknesses of the Z-electrode ZP, the transparent elastic layer 114, and the supporting layer 113 which are pushed back by the spacer 800 when touched is reduced by pressing.

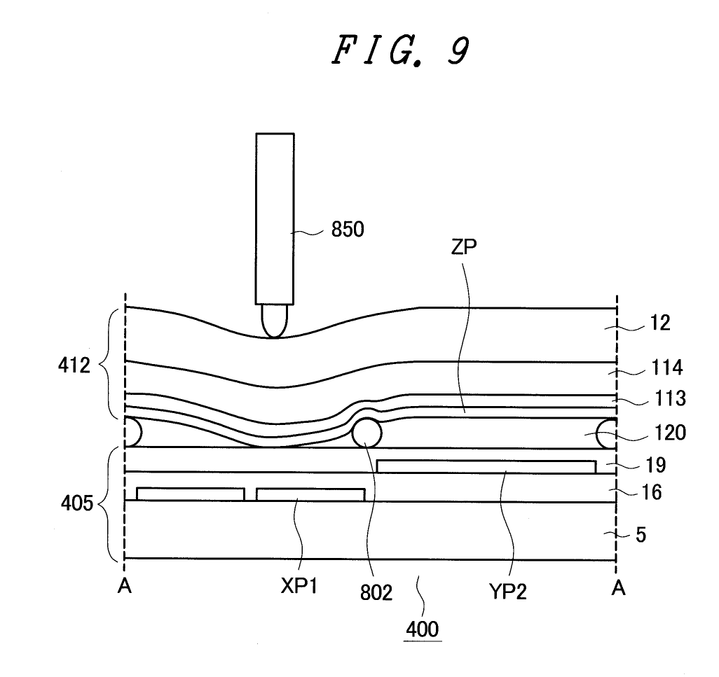

FIG. 9 shows a case where the spacers 800 are granular spacers 802. The granular spacers 802 are formed by appropriately dispersing polymer beads, glass beads, or the like having a uniform grain diameter and by fixing them on the second insulating film 19.

Also in a case of the granular spacer 802 shown in FIG. 9, since all the Z-electrode ZP, the transparent elastic layer 114, and the supporting layer 113 are softer than the granular spacer 802, the Z-electrode ZP elastically deforms. Therefore, also in a case of the granular spacer 802, the gap Dxyz is narrowed to such an extent that the amount of change in the capacitance Cxy can be detected. Moreover, since both the transparent elastic layer 114 and the supporting layer 113 are formed of a flexible material, the granular spacer 802 is also brought into such a state that it is buried into the Z-electrode ZP.

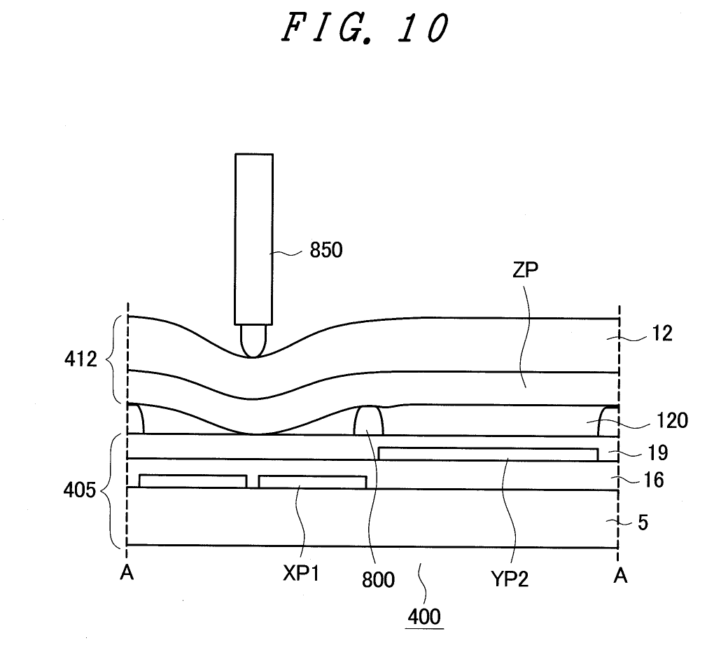

FIG. 10 shows a case where the Z-electrode ZP is formed of a transparent elastic film having conductivity. In FIG. 10, the Z-electrode ZP is formed of a flexible layer with a similar thickness to the transparent elastic layer 114 described above, which makes the Z-electrode ZP sufficiently deformable by pressing. That is, since the transparent elastic layer 114 cannot be compressed over its thickness, the thickness needs to be sufficiently great relative to the amount of displacement by touch.

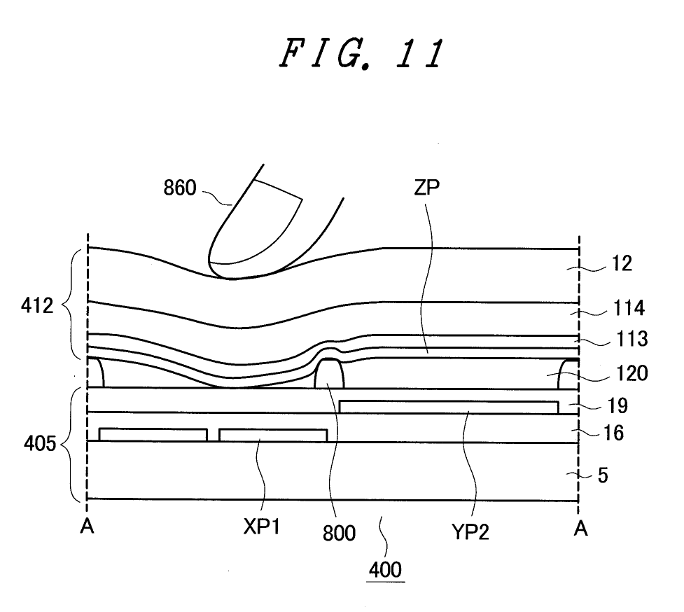

FIG. 11 shows a case where input means is a finger 860 or the like. Also in a case of touching with the finger 860, the Z-electrode ZP elastically deforms, and the gap Dxyz is narrowed to such an extent that the amount of change in the capacitance Cxy can be detected.

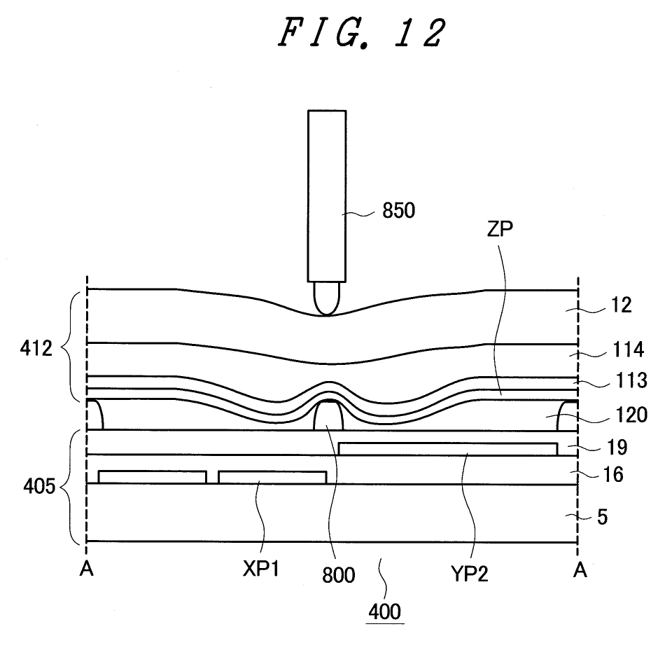

FIG. 12 shows a case where the pen 850 touches just above the spacer 800. The second transparent substrate 12 is bent by the touch, and along with the bending, the Z-electrode ZP abuts on the spacer 800. Also in this case, since all the Z-electrode ZP, the transparent elastic layer 114, and the supporting layer 113 are sufficiently softer than the spacer 800, the Z-electrode ZP deforms such that the spacer 800 is buried into the Z-electrode ZP. That is, although the Z-electrode ZP on a line connecting the spacer 800 with the pen 850 is compressed by the spacer 800, the Z-electrode ZP around the spacer 800 deforms so as to enclose the spacer 800. Accordingly, the gap Dxyz around the spacer 800 is also narrowed to such an extent that the amount of change in the capacitance Cxy can be detected. In this manner, highly accurate position detection is possible even in the vicinity of the spacer 800 compared to the related art.

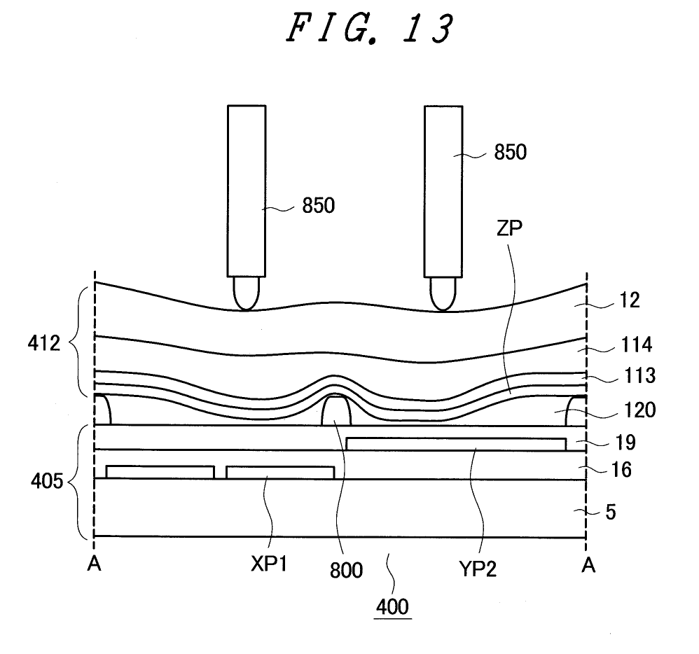

Next, FIG. 13 shows a case where the spacer 800 is positioned between two points which are touched simultaneously. In this case, although the second transparent substrate 12 is bend by the touch, the gap Dxyz does not change at the position of the spacer 800 because the gap is maintained by the spacer 800. In the vicinity of the spacer 800, on the other hand, the Z-electrode ZP is displaced with the spacer 800 as a fulcrum point, so that the amount of change in the capacitance Cxy every two points can be detected.

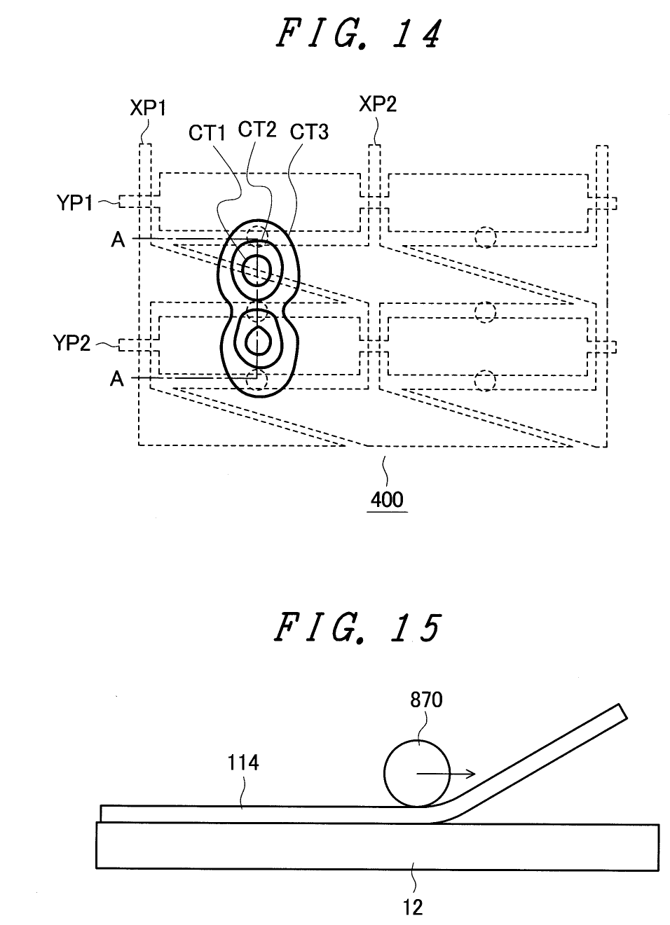

FIG. 14 shows the amount of change (detected intensity) in the capacitance Cxy when two points close to each other are pressed, and the spacer 800 is present therebetween. In FIG. 14, the lines CT1 and CT2 each showing the same capacitance value are disconnected between the two points, so that the two points cannot be separately detected based on the capacitance change.

Since, in addition to the presence of the spacer 800, all the Z-electrode ZP, the transparent elastic layer 114, and the supporting layer 113 are formed of a flexible material, it is also possible to cope with the problem caused by the spacer 800 maintaining the gap Dxyz. That is, the force of restricting the displacement of the second transparent substrate 12 with the spacer 800 is absorbed at the position of the spacer 800 because the thicknesses of the Z-electrode ZP, the transparent elastic layer 114, and the supporting layer 113 are compressed. Therefore, also the fact that the gap Dxyz in the vicinity of the spacer 800 can deform to such an extent that the amount of change in the capacitance Cxy can be detected enables the detection that the two points are pressed.

Even when the spacer 800 is not present on the line connecting the two points, the spacer 800 is present between the XY-electrode substrate 405 and the Z-electrode substrate 412, so that the spacer 800 serves as a fulcrum point, which enables the detection that the two points are pressed.

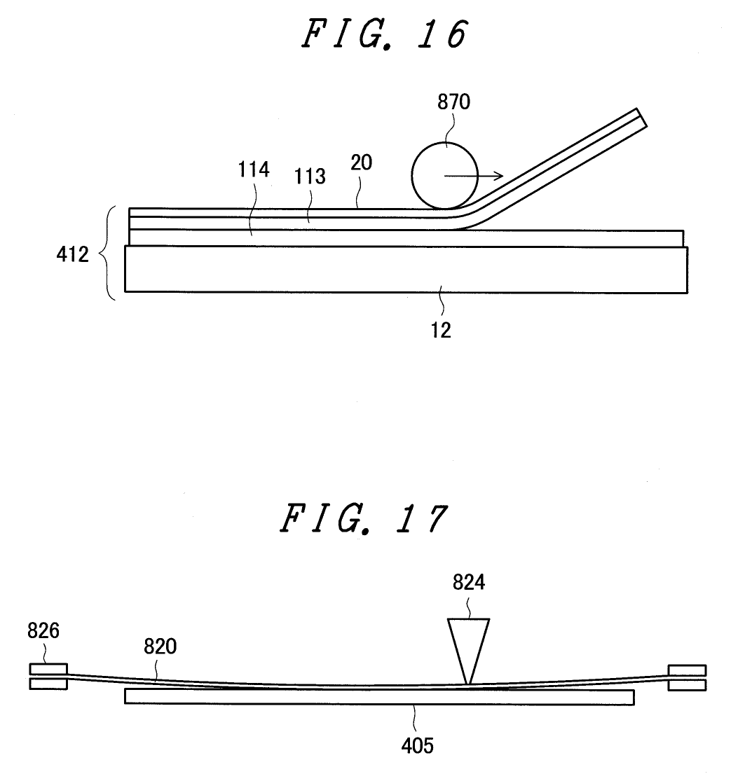

Next, FIGS. 15 and 16 show a method for manufacturing the Z-electrode substrate 412. FIG. 15 shows a method for forming the transparent elastic layer 114 on the second transparent substrate 12. First, the second transparent substrate 12 is prepared. Next, the transparent elastic layer 114 having a sheet shape is attached from one end of the second transparent substrate 12 while pressing with a roller 870. By attaching a flexible, sheet-like material, a uniform layer can be formed by a simple apparatus and method.

In FIG. 16, the supporting layer 113 separately prepared and having an elastic conductive film 20 formed thereon is attached from one end of the second transparent substrate 12 having the transparent elastic layer 114 attached thereon while pressing with the roller 870. The elastic conductive film 20 is used as the Z-electrode ZP described above.

When a large-sized substrate is prepared for the second transparent substrate 12 so that a plurality of touch panels can be obtained, and similarly, a large-sized, sheet-like transparent elastic layer 114, the supporting layer 113, and the elastic conductive film 20 are attached, a great number of touch panels can be manufactured at one time. If the elastic conductive film 20 can be attached to the transparent elastic layer 114 without using the supporting layer 113, or the supporting layer 113 can be removed easily after attaching the elastic conductive film 20, the supporting layer 113 does not necessarily need to be left in the touch panel 400.

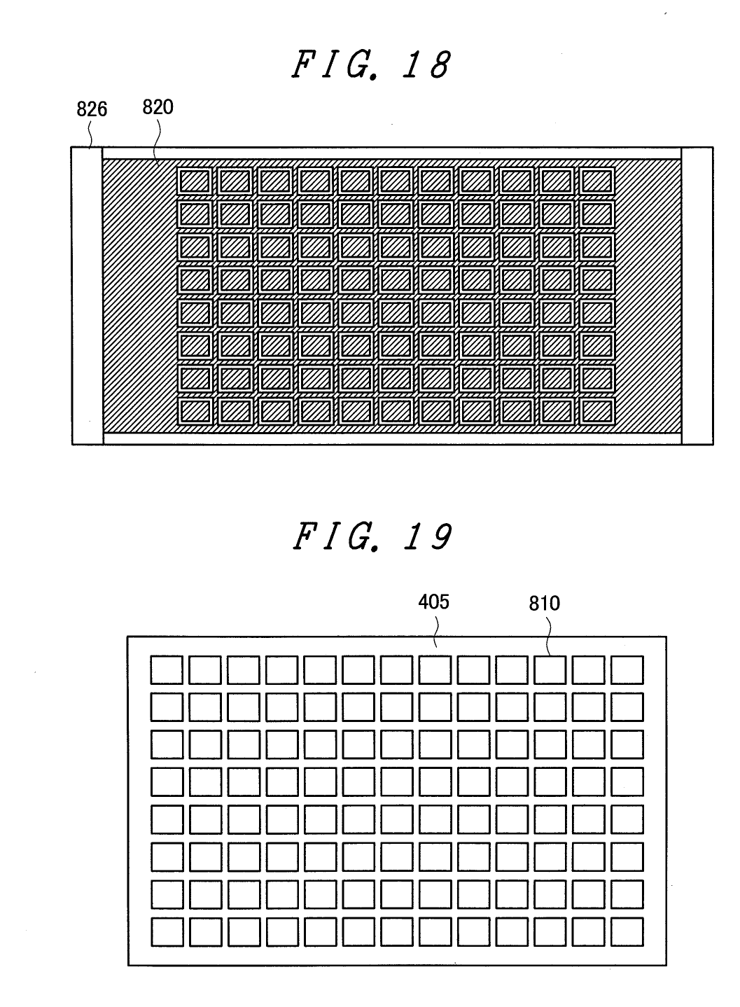

FIG. 17 shows a manufacturing method for forming the spacer 800 and a sealing material 810. The spacer 800 and the sealing material 810 can be formed by screen printing. For screen printing, a screen plate 820 shown in FIG. 18 is used. Holes are formed through the screen plate 820 in shapes of the spacer 800 (not shown in FIG. 18) and the sealing material 810. Tension is applied to the screen plate 820 using a plate frame 826, and the material substance of the spacer 800 and the sealing material 810 is squeezed through the holes using a squeegee 824, whereby the spacer 800 and the sealing material 810 are transferred onto the XY-electrode substrate 405.

It is also possible to only form the spacer 800 on the XY-electrode substrate 405 and use a pressure-sensitive adhesive double-coated tape or the like for the sealing material 810. It is also possible to form the spacer 800 on the XY-electrode substrate 405 side and form the sealing material 810 on the Z-electrode substrate 412 side.

FIG. 19 shows a state where the sealing materials 810 are formed on the XY-electrode substrate 405. FIG. 19 illustrates a case of simultaneously manufacturing the plurality of touch panels 400. It is assumed that the spacers 800 are also formed although not shown. After transferring the spacers 800 and the sealing materials 810, the spacers 800 are irradiated with ultraviolet radiation or heated to cure the spacers 800 to an extent.

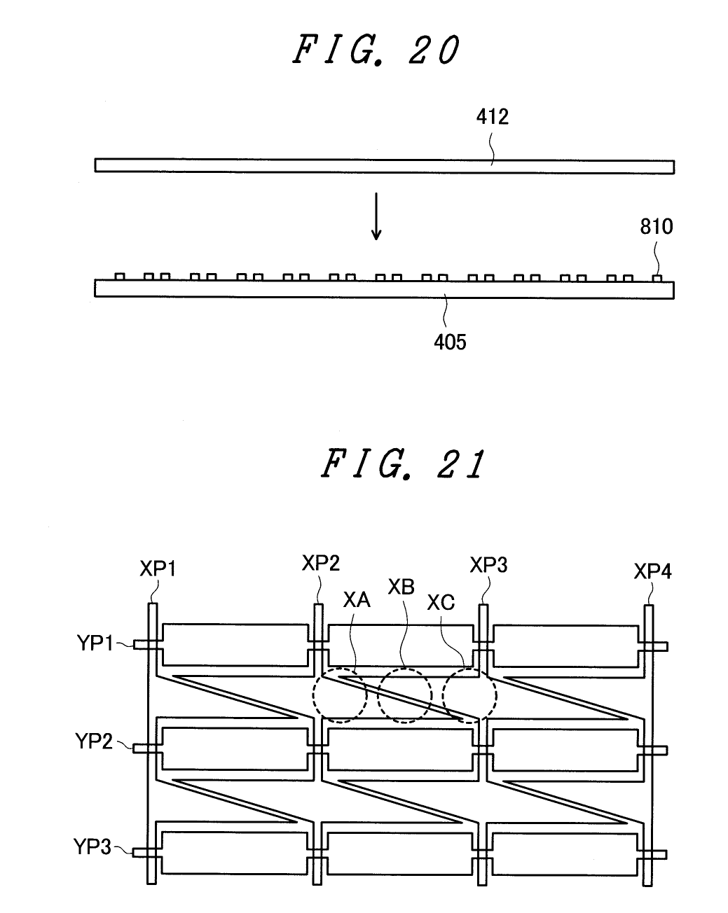

As shown in FIG. 20, the XY-electrode substrate 405 having the spacers 800 and the sealing materials 810 formed thereon and the Z-electrode substrate 412 are overlapped, and the entire surface is irradiated with ultraviolet radiation or heated to fix both substrates with each other with the sealing materials 810. The spacers 800 are first cured for preventing the spacers 800 from crushing due to the Z-electrode substrate 412 when the XY-electrode substrate 405 and the Z-electrode substrate 412 are overlapped. After fixing both substrates with each other, the touch panels 400 are cut into individual ones.

Next, with reference to FIG. 21, the signal component of each of the electrodes when the position of a contact point is changed in the horizontal direction in a case of a small contact surface like the pen 850 will be described.

The capacitance change of the capacitance Cxy described with reference to FIG. 4 depends on the area of the portion where the gap Dxyz is narrowed. The area of the portion where the gap Dxyz is narrowed is called a detecting area. In FIG. 21, detecting areas are indicated by circles XA, XB, and XC for the description. When an overlapping area of a detecting area with the X-electrode XP or the Y-electrode YP is large, the signal component is large. In contrast, when the overlapping area is small, the signal component is small.

FIG. 21 shows a state where the position of a contact point is changed on the X-electrode between the two neighboring X-electrodes XP2 and XP3. XA is located in the vicinity of the center of the X-electrode XP2; XB is located in the vicinity of the middle between the X-electrodes XP2 and XP3; and XC is located in the vicinity of the center of the X-electrode XP3. In FIG. 21, the Z-electrode ZP and the spacers 800 are not illustrated for simplifying the drawing.

At the position of the detecting area XA, an overlapping portion of the detecting area XA with the X-electrode XP2 is large, and the detecting area XA has little overlap with the X-electrode XP3. Therefore, the signal component of the X-electrode XP2 is large, and the signal component of the X-electrode XP3 is small.

At the position of the detecting area XB, an overlapping area of the X-electrode XP2 with the detecting area XB and an overlapping area of the X-electrode XP3 with the detecting area XB are substantially equal to each other. Therefore, the signal component calculated is substantially equal between the X-electrodes XP2 and XP3.

At the position of the detecting area XC, an overlapping portion of the detecting area XC with the X-electrode XP3 is large, and the detecting area XC has little overlap with the X-electrode XP2. Therefore, the signal component of the X-electrode XP3 is large, and the signal component of the X-electrode XP2 is small.

The control operation unit 103 performs a centroid calculation using the signal component of each of the electrodes to calculate input coordinates contacted by the pen 850 through a touch operation.

When a nearly equal signal component is obtained in the X-electrodes XP2 and XP3 like in the detecting area XB, since the position of the center of gravity is in the middle between the X-electrodes XP2 and XP3, the input coordinates can be calculated. On the other hand, when the signal component of one X-electrode is very large like in the detecting areas XA and XC, since the position of the center of gravity is in the vicinity of the X-electrode whose large signal component is detected, the input coordinates can be calculated similarly.

As described above, the electrode shape of the X-electrode is formed in such a shape that becomes narrow toward a neighboring electrode, whereby a centroid calculation is possible even when the electrode gap of the X-electrode is wide compared to the detecting area, and the position can be detected with high accuracy. Accordingly, by enlarging the electrode gap of the X-electrode compared to the detecting area, the number of electrodes can be reduced more than in conventional electrode patterns. Even when the electrode shape of the X-electrode has a discrete shape with the Y-electrode interposed between the X-electrodes, the Z-electrode ZP which is electrically floating is arranged so as to stride over the X-electrode XP and the Y-electrode YP neighboring to each other, whereby input coordinates in the X-direction can be detected with good accuracy on the entire surface of the touch panel.

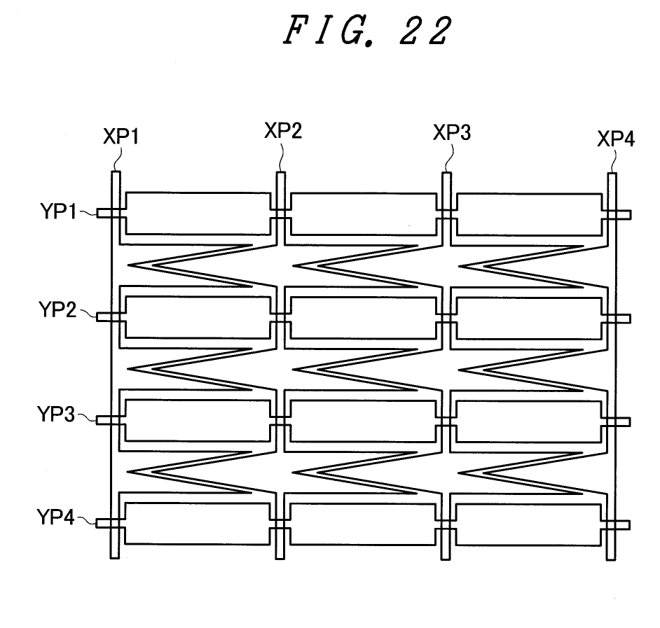

FIG. 22 shows a case of changing the shape of the X-electrode XP. The Y-electrode YP has the same shape in FIGS. 2, 21, and 22. While the shape of the X-electrode XP is a convex shape toward both right and left sides in FIG. 21, it is a convex shape toward one neighboring X-electrode XP1 and is a concave shape toward the other neighboring X-electrode XP3 as shown by the X-electrode XP2 in FIG. 22.

All in FIGS. 2, 21, and 22, the X-electrode XP has the same feature in that the area decreases as the electrode approaches the center of the neighboring X-electrode XP, and that the area increases closer to the center of the relevant X-electrode XP. Therefore, it can be expected that even the X-electrode XP shown in FIG. 22 provides the same effect as that of FIG. 21. The shape of the X-electrode is not limited to the shapes of FIGS. 21 and 22 so long as the area decreases as the electrode approaches the center of the neighboring X-electrode XP, and the area increases closer to the center of the relevant X-electrode XP.

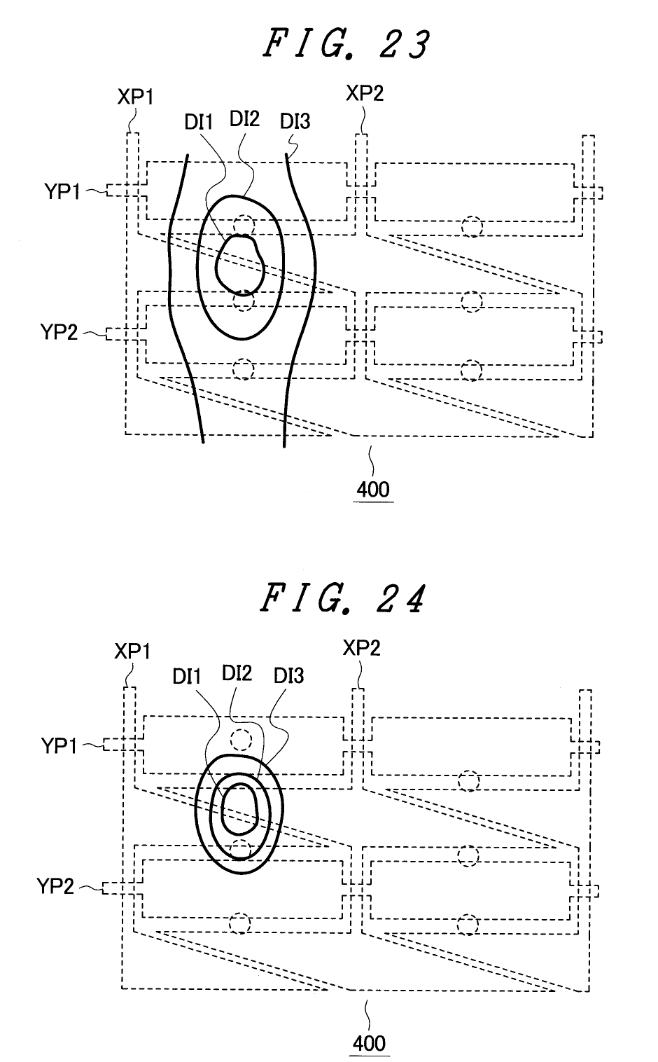

Next, a change in detecting area relative to the resistance value of the Z-electrode ZP will be described. In FIGS. 23 to 25, it is assumed that the Z-electrode ZP is formed to overlap both the X-electrode XP and the Y-electrode YP (so-called a solid electrode).

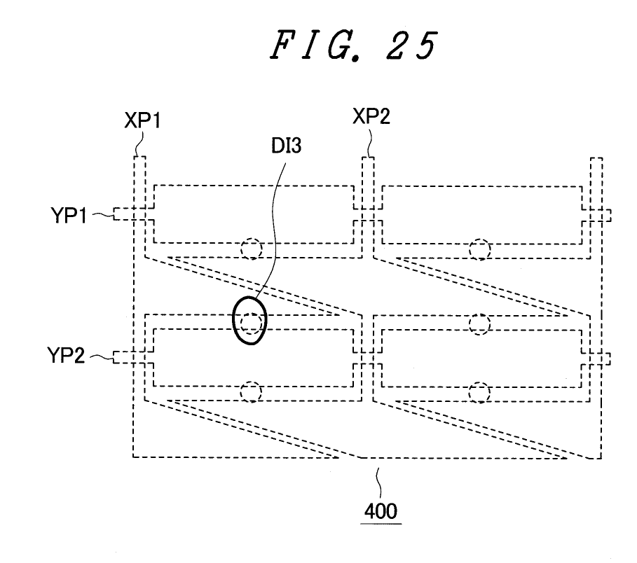

FIG. 23 shows the detected intensities when the sheet resistance value of the Z-electrode ZP is low; FIG. 24 shows the detected intensities when the sheet resistance value of the Z-electrode ZP is appropriate and the detecting area is proper; and FIG. 25 shows the detected intensities when the sheet resistance value of the Z-electrode ZP is high.

Detected intensities DI1 to DI3 shown in FIG. 23 show detected intensities when the sheet resistance value of the Z-electrode ZP is 1.0×10³ Ω/□. The detected intensities are in the relationship of DI1>DI2>DI3.

Both the areas of the detected intensities DI1 and DI2 are increased, and further, the detected intensity D13 extends beyond the neighboring Y-electrode YP1. Therefore, it is difficult to detect the position with high accuracy.

Next, FIG. 24 shows the detected intensities when the sheet resistance value of the Z-electrode ZP is 1.0×10⁵ Ω/□. The area of the detected intensity DI3 or higher which is effective as a detecting area overlaps the neighboring electrodes. Therefore, the position can be detected with high accuracy.

Next, FIG. 25 shows the detected intensities when the sheet resistance value of the Z-electrode ZP is 1.0×10⁷ Ω/□. Ranges showing the detected intensities DI1 and DI2 are lost, and the area of the detected intensity DI3 or higher which is effective as a detecting area does not sufficiently overlap the neighboring electrodes. Therefore, it is difficult to detect the position with high accuracy.

It is considered that when an ITO film for forming the X-electrode XP and the Y-electrode YP is formed with a sheet resistance value of around 1.0×10³ Ω/□, since the distance between the Z-electrode ZP, and the X-electrode XP and the Y-electrode YP which the Z-electrode ZP overlaps is short compared to the drawn distance of the X-electrode XP and the Y-electrode YP, the detecting area is widened with a sheet resistance value of the Z-electrode ZP at a similar level.

When the sheet resistance value of the Z-electrode ZP exceeds 1.0×10⁷ Ω/□, the Z-electrode ZP does not sufficiently function as a conductive member for a detection circuit, whereby an effective detected intensity is extremely decreased.

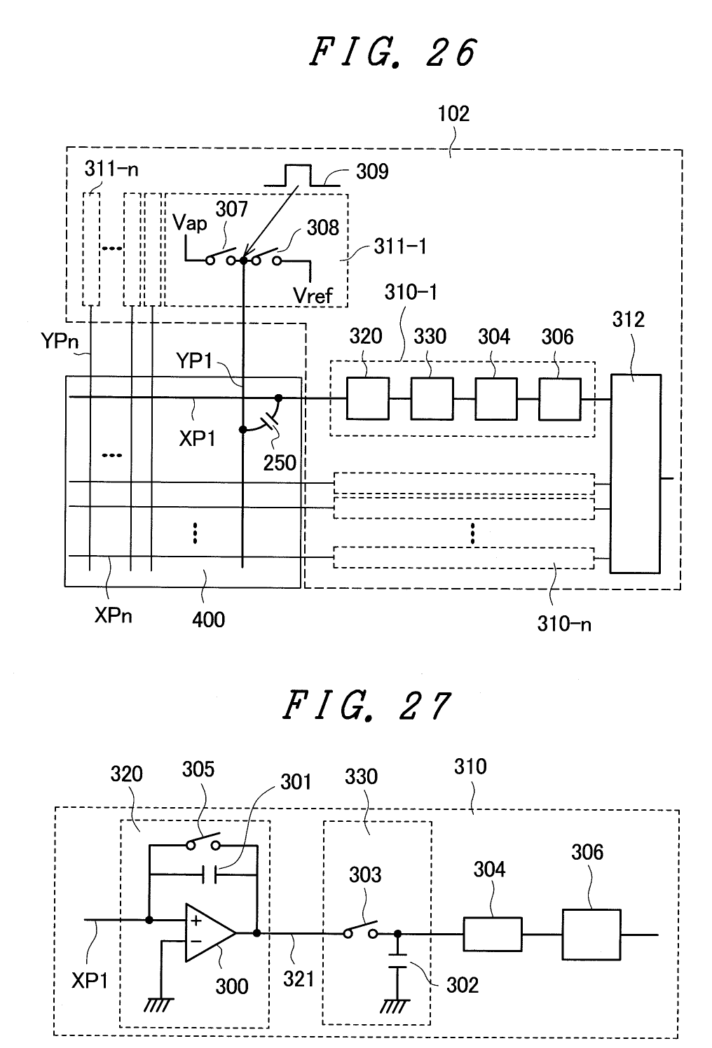

Next, a detecting method will be described. FIG. 26 is a schematic block diagram showing a circuit configuration of the capacitance detecting unit 102; and FIG. 27 shows a schematic configuration of a signal readout unit 310. The capacitance detecting unit 102 includes a signal input unit 311 which inputs a signal to the Y-electrode YP, the signal readout unit 310 which reads out a signal from the X-electrode XP, and a memory unit 312.

In FIG. 26, the circuit configuration with only one pair of the X-electrode XP1 and the Y-electrode YP1 is illustrated. However, it is assumed that a signal readout unit 310-n and a signal input unit 311-n having the same configuration are respectively connected to each of the X-electrodes XP and each of the Y-electrodes YP formed on the touch panel 400.

The signal input unit 311 applies a signal 309 like a waveform in the drawing to the Y-electrode YP by switching between an applied voltage Vap and a reference potential Vref through switches 307 and 308, thereby applying voltage. The signal readout unit 310 includes an integrator circuit 320 formed of an operational amplifier 300, an integral capacitor 301, and a reset switch 305, a sample-and-hold circuit 330 formed of a sample switch 303 and a hold capacitor 302, a voltage buffer 304, and an analog-digital converter 306.

Hereinafter, the operation of the capacitance detecting unit 102 will be schematically described. In the initial state of the capacitance detecting unit 102, it is assumed that the integral capacitor 301 is not charged. The switch 307 is first brought into the on state from the initial state, so that voltage is applied to the Y-electrode YP1 by the signal input unit 311. Thus, a coupling capacitance 250 (corresponding to the combined capacitance Cxyz described above) between the X-electrode and the Y-electrode is charged until the Y-electrode YP1 reaches the applied voltage Vap.

At this time, the potential of the X-electrode XP1 is fixed to the ground potential at all times by the negative feedback effect of the operational amplifier 300. Accordingly, the charged current flows through the integral capacitor 301 into an output terminal 321 of the operational amplifier 300.

When the voltage of the output terminal 321 of the integrator circuit 320 due to this operation is denoted by Vo; the capacitance of the coupling capacitance 250 is denoted by Cdv; and the capacitance of the integral capacitor 301 is denoted by Cr, the voltage is expressed by the formula: Vo=−Vap(Cdv/Cr), and it depends on the magnitude Cdv of the coupling capacitance 250 between the X-electrode and the Y-electrode.

After the output voltage Vo of the integrator circuit 320 is determined by the operation, the output voltage Vo is held by the sample-and-hold circuit 330. In the sample-and-hold circuit 330, the sample switch 303 is first brought into the on state and then into the off state after elapsing a predetermined time, so that the output voltage Vo is held in the hold capacitor 302. The voltage Vo held in the hold capacitor 302 is input to the analog-digital converter 306 through the voltage buffer 304 and converted into digital data. Although the hold voltage of the sample-and-hold circuit 330 is input to the analog-digital converter 306 through the voltage buffer 304, the voltage buffer 304 may be configured to have a voltage amplification factor.

Also for the other X-electrodes than the X-electrode XP1, the signal readout unit connected to each of the X-electrodes performs the same operation as that of the signal readout unit 310 connected to the X-electrode XP1, and an integrator circuit output potential due to an input signal from the Y-electrode YP1 is read out simultaneously with the X-electrode XP1.

Output of the signal readout unit 310 connected to each of the X-electrodes XP is input to the memory unit 312, and the output data is held in the memory unit 312. The memory unit 312 performs transaction of the hold data with the control operation unit 103 shown in FIG. 1.

The signal 309 is sequentially applied to the Y-electrodes YP, so that voltage is successively applied to the Y-electrodes YP to detect the capacitance. Prior to the detection of the capacitance, the reset switch 305 is controlled so as to be once brought into the on state and then into the off state in the signal readout unit 310, whereby the integral capacitor 301 of each of the integrator circuits is reset. From then on, the same operation is repeated.

In this case, the timing of applying the signal 309 to a given Y-electrode YP has been determined, and a pulse-like signal is applied to a specified Y-electrode YP during a specified period, so that it can be determined, due to count such as a reference clock, from which of the Y-electrodes YP the signal output from the X-electrode XP is output.

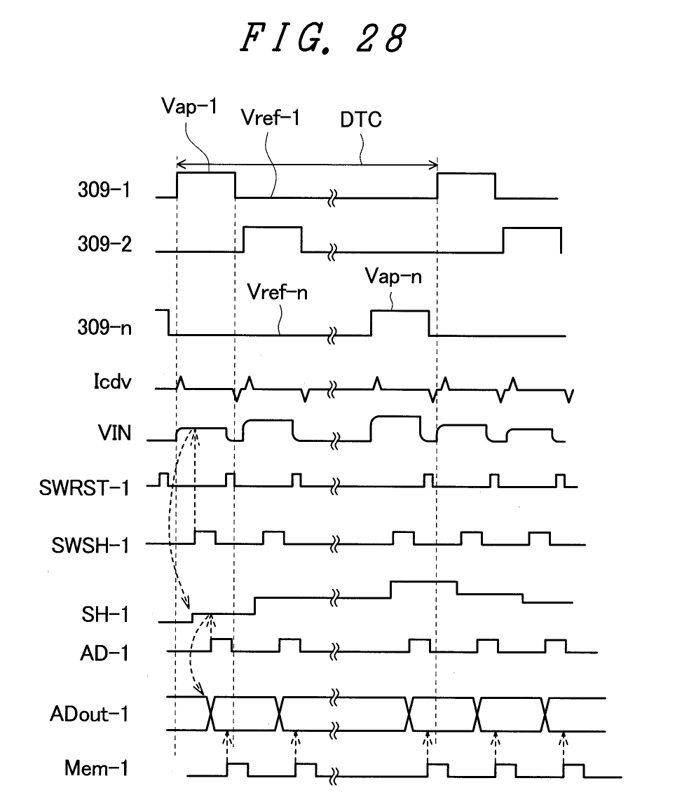

FIG. 28 is a timing diagram showing operation of the capacitance detecting unit 102 shown in FIG. 26. Signals 309-1 to 309-n are operation signal waveforms of the signal input units 311-1 to 311-n, and the signal input units 311-1 to 311-n sequentially output the signal 309 from the Y-electrodes YP1 to YPn during a detection cycle DTC. Hereinafter, the signal 309 is also called a pulse signal.

A waveform Icdv is a current waveform flowing into the coupling capacitance 250 (Cdv) between the X- and Y-electrodes shown in FIG. 26. When the potential of the Y-electrode YP rises due to the input signal of the signal input unit 311, current transiently flows. Also when the potential of the Y-electrode YP drops, current transiently flows.

A waveform VIN is an output waveform of the integrator circuit 320 shown in FIG. 26, that is, the voltage Vo of the output terminal 321 of the integrator circuit 320, corresponding to the pulse signal 309. A waveform SWRST-1 represents a control signal waveform of the reset switch 305 shown in FIG. 27.

When the reset switch control signal SWRST-1 rises, the integrator circuit 320 is reset; the waveform VIN drops; and the signal readout unit 310 is brought into the initial state. Thereafter, the pulse signal 309 is input from the signal input unit 311, so that the output waveform VIN of the integrator circuit 320 rises again. From then on, this operation is repeated. In the example, an example where the amplitude of the waveform VIN changes is shown, which shows that the magnitude of the detected capacitance changes every time the Y-electrode which inputs a signal changes. That is, the example shows that when a contact to be detected is made on the touch panel 400, the signal VIN which reflects this capacitance change changes locally so as to indicate the contact point.

A waveform SWSH-1 is a signal which controls the sampling switch 303 of the sample-and-hold circuit 330 shown in FIG. 26. A waveform SH-1 represents an output signal of the sample-and-hold circuit 330. In the period of time when the signal SWSH-1 rises, the sampling switch 303 is brought into the on state, and an input potential to the sample-and-hold circuit 330, that is, the output potential (the waveform VIN) of the integrator circuit 320 is applied to the hold capacitor 302. When the signal SWSH-1 drops, the sampling switch 303 is brought into the off state, and the applied voltage is held in the hold capacitor 302. As shown by the waveform SH-1, output of the sample-and-hold circuit 330 is updated every sampling operation.

A waveform AD-1 represents a signal which controls the analog-digital converter 306 shown in FIG. 26; and a waveform ADout-1 represents an output signal of the analog-digital converter 306. Every time the output waveform SH-1 of the sample-and-hold circuit is updated, the signal AD-1 is issued with a predetermined time lag. When the signal AD-1 is output, the analog-digital converter 306 outputs the input voltage as the digital data ADout-1 having a predetermined resolution.

A waveform Mem-1 represents a write control signal to the memory unit 312 shown in FIG. 26. Every time the signal ADout-1 is updated, the signal Mem-1 is issued with a predetermined time lag. When the signal Mem-1 is issued, the digital data ADout-1 is written into the memory unit 312.

The signal waveform change caused by the operation of the capacitance detecting unit 102 has been described while focusing on the signal readout unit 310 shown in FIG. 26. The signal readout unit (310-n) connected to other X-electrode also has the same operation and waveform change.

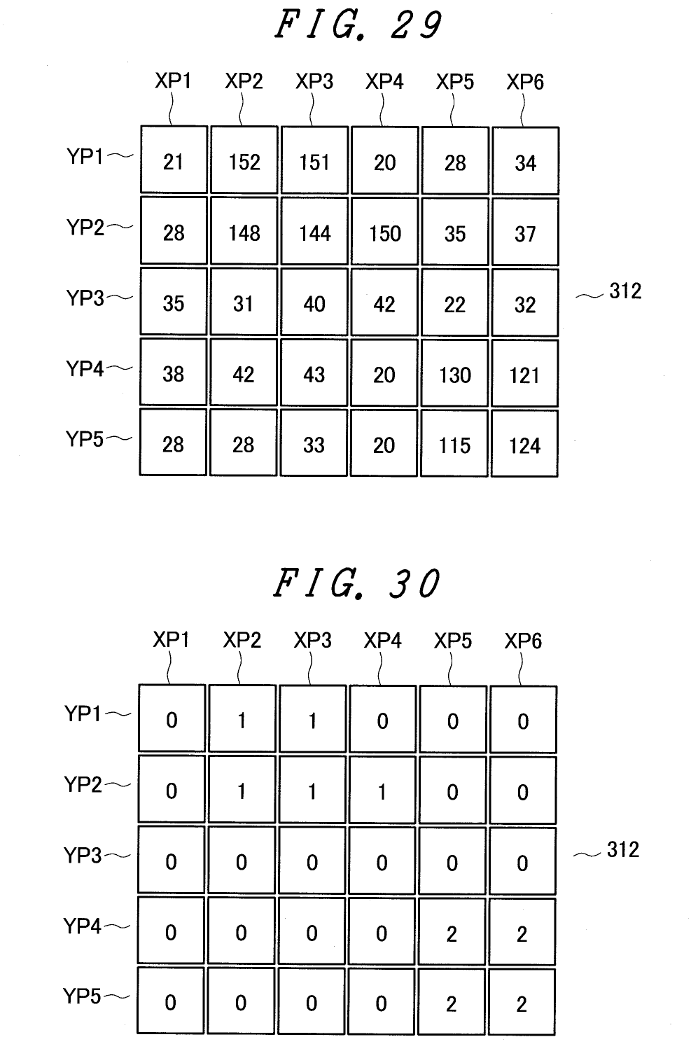

FIG. 29 shows detected values stored in the memory unit 312 shown in FIG. 26, in which the detected values are sorted by fetching timing and related to coordinates determined by the X- and Y-electrodes. In this case, each of squares shows a position where respective electrodes shown on the horizontal axis and the vertical axis intersect with each other. The numerical value in each of the squares is a value reflecting a capacitance value at each intersection point obtained by the detecting step. As the numerical value is greater, the capacitance value is greater. Based on the magnitude of the numerical value, threshold value determination, and the like, the presence or absence of a contact to be detected on the touch panel 400 is determined.

The threshold value determination is performed on the state of FIG. 29. Specifically, when the numerical value exceeds 100, it is determined that a contact is present. FIG. 30 shows the determination results, in which the determination results are assigned with a common number in each group by a grouping process. After this process, the distribution of signal intensity is analyzed in each group and converted into contact coordinates to be detected on the touch panel 400.

In this case, it is conceivable that the grouping process is a generally known labeling process or the like. However, the grouping process is not limited to this. Moreover, it is apparent that means for calculating contact coordinates to be detected on the touch panel 400 from the data obtained as shown in FIG. 29 by the capacitance detecting step is not limited to the method described herein.

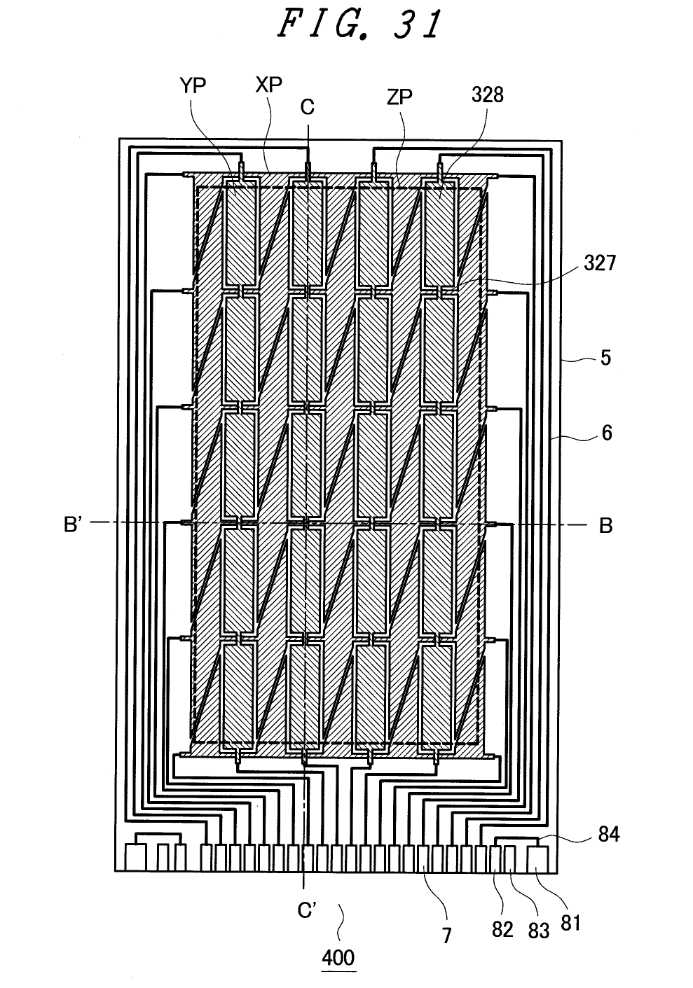

Next, FIG. 31 is a schematic plan view of the touch panel 400. FIG. 31 shows the touch panel 400 when used in portrait format. As described above, the X-electrodes XP, the Y-electrodes YP, and the Z-electrode ZP are disposed on the transparent substrate 5. In FIG. 31, the Z-electrode ZP is indicated by dashed lines.

The X-electrodes XP and the Y-electrodes YP are disposed such that individual electrodes (pad portions) 328 are alternately arranged. At the fine line portion 327 between the individual electrodes 328, the X-electrode XP and the Y-electrode YP intersect with each other. At the intersecting portion, the X-electrode XP and the Y-electrode YP intersect with each other via an insulating film. At the fine line portion 327, the width of the electrode is narrowed, so that the capacitance generated at the intersecting portion is small.

The fine line portion 327 is disposed at the intersecting portion to narrow the width of the electrode so that the capacitance generated at the intersecting portion is small. For similar purposes, the X-electrode XP has a so-called diamond shape in which the electrode width is wide at the central portion and the electrode width is narrowed as the electrode approaches the intersecting portion. As shown by the X-electrode XP, when the electrode is formed in a diamond shape, the electrode can be formed such that the electrode width can be made wide to the vicinity of the intersecting portion by narrowing the electrode width as the electrode approaches the intersecting portion, making it possible to decrease an increase in the resistance value of the electrode caused by the narrowed electrode width at the intersecting portion. In FIG. 31, although the X-electrode XP is formed in a diamond shape, it is more effective when the X-electrode XP and the Y-electrode YP are formed in a diamond shape.

Wiring lines 6 are disposed at the peripheral portion of the touch panel 400 and supply signals to the electrodes. The wiring lines 6 are connected to connection terminals 7 formed at one edge of the touch panel 400. An external device is electrically connected to the connection terminals 7. Back face connection pads 81 are formed in alignment with the connection terminals 7.

A back face transparent conductive film is formed on the back face of the transparent substrate 5 for purposes of reducing noise, and the back face connection pads 81 are formed for supplying voltage to the back face transparent conductive film. The back face connection pad 81 is formed to have a large area compared to the connection terminal 7, so that the work of connecting the back face connection pad 81 to the back face transparent conductive film can be easily done. Reference numeral 82 denotes a connection terminal for the back face connection pad 81. A wiring line 84 is connected from the connection terminal 82 to the back face connection pad 81. Reference numeral 83 denotes a dummy terminal.

The wiring line 6 is formed to be capable of supplying a signal from both upper and lower ends of the X-electrode XP and formed to be capable of supplying a signal from both right and left ends of the Y-electrode YP. Therefore, for example, since the wiring line 6 which supplies a signal to the Y-electrode YP is drawn for a long distance from the end where the terminals 7 are formed to the opposite end, the wiring line is desirably formed with a low resistance member.

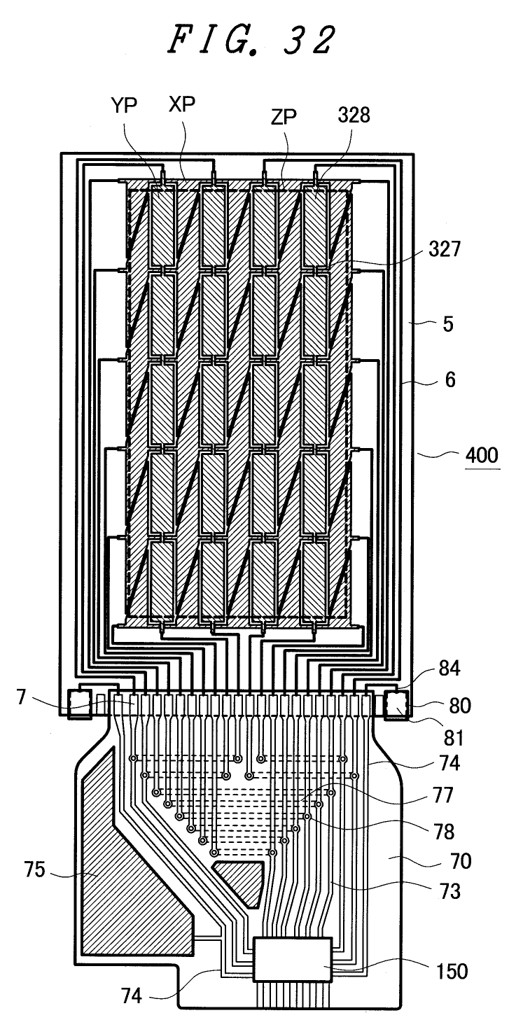

FIG. 32 shows the touch panel 400 to which a flexible printed board 70 is connected. A drive circuit 150 is mounted on the flexible printed board 70. Signals output from the drive circuit 150 are supplied to the touch panel 400 via the flexible printed board 70. In the drive circuit 150, the circuit illustrated in FIG. 26 is formed.

The signals output from the drive circuit 150 are first supplied to wiring lines 73 formed on the flexible printed board 70. A through hole 78 is formed through each of the wiring lines 73. Intersecting wiring lines 77 on the back face and the wiring lines 73 are electrically connected through the through holes 78.

Each of the intersecting wiring lines 77 intersects with a number of the wiring lines 73 and is connected to the wiring line 73 again through the through hole 78 formed at the other end. The intersecting wiring line 77 and the wiring line 73 intersect at right angles so that the overlapping area is as small as possible. Each of wiring lines 74 is a wiring line which supplies voltage to the back face connection pad 81 and to which the ground potential or the like is supplied.

A conductive member 80 is connected to each of the back face connection pads 81. Voltage is supplied from the back face connection pad 81 to the back face transparent conductive film through the conductive member 80. It is also possible to supply the ground potential to a shield pattern 75 via the wiring line 74.

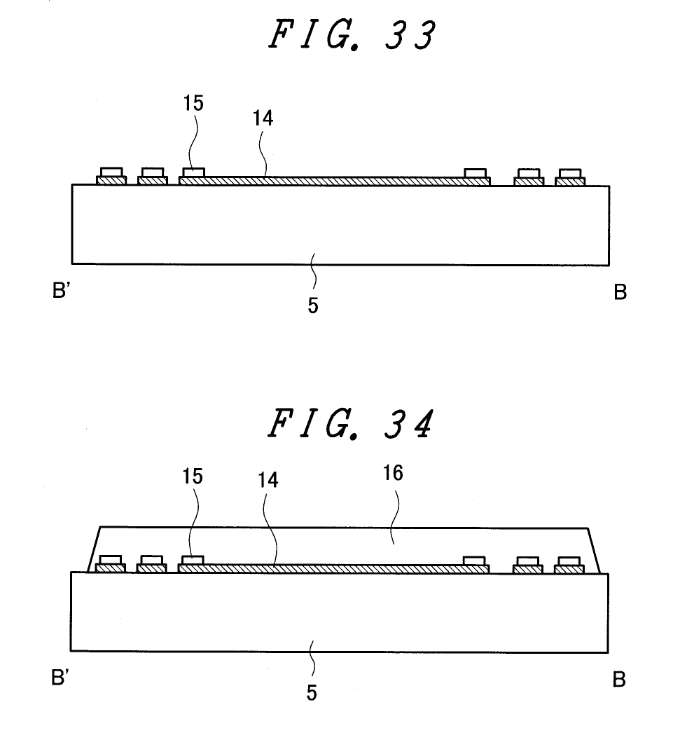

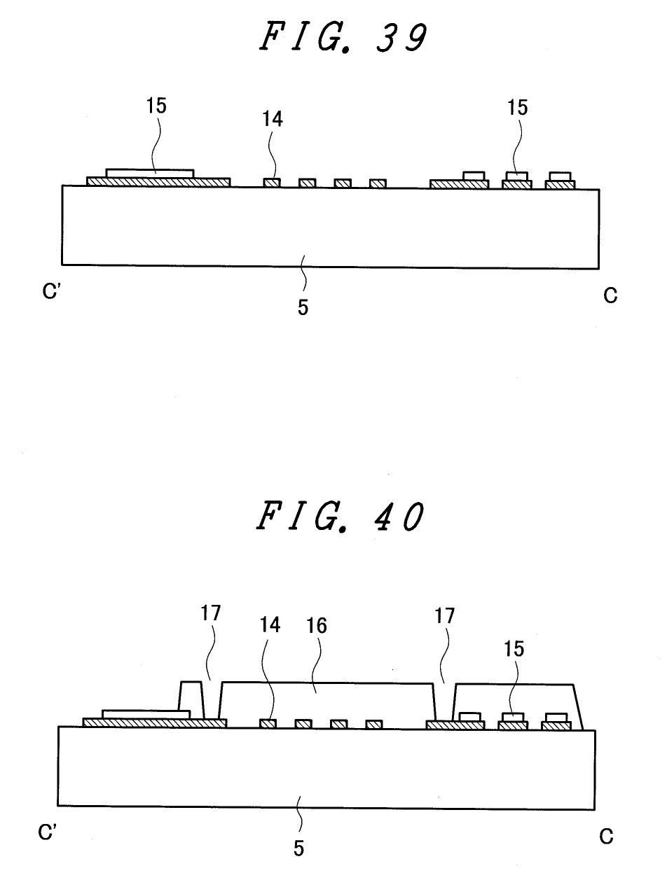

Next, a method for manufacturing the touch panel of the embodiment will be described with reference to FIGS. 33 to 47. FIGS. 33 to 38 show schematic cross-sections at respective process stages along the line B-B′ of FIG. 31. Similarly, FIGS. 39 to 44 show schematic cross-sections at respective process stages along the line C-C′ of FIG. 31.

First, with reference to FIGS. 33 and 39, a first step will be described. In the step shown in FIGS. 33 and 39, a first ITO film 14 (Indium Tin Oxide) is deposited to a thickness of about 15 nm on the transparent substrate 5 such as a glass substrate. Thereafter, a silver alloy film 15 is deposited to a thickness of about 200 nm. A resist film pattern is formed by a photolithography process, and the silver alloy film 15 is patterned. After the resist film is removed; a next resist film pattern is formed by a photolithography process; and the first ITO film 14 is patterned. Thereafter, the resist film is removed, and patterns of the ITO film 14 and the silver alloy film 15 patterned as shown in FIGS. 33 and 39 are formed. Since the pattern of the silver alloy film 15 is opaque, it is removed from a portion extended over a display region of a display panel to be overlapped later for avoiding the silver alloy film 15 being visible, and only a wiring pattern of the wiring line 6 at the periphery is formed of the silver alloy film 15.

The electrodes of the XY-electrode substrate 405 can be formed of the first ITO film 14, and, for example, the X-electrode XP described with reference to FIG. 2 can be formed using the first ITO film 14.

Next, with reference to FIGS. 34 and 40, a second step will be described. On the substrate on which the patterns of the first ITO film 14 and the silver alloy film 15 are formed, the first insulating film 16 is applied and processed by patterning using a photolithography technique. For the first insulating film 16, a film containing SiO₂ as a main component is desirably applied to a thickness of 1 μm or greater. As shown in FIG. 40, contact holes 17 are disposed at the peripheral portion. At the connection terminal 7 which is used for the connection with an external circuit, the first insulating film pattern 16 is removed.

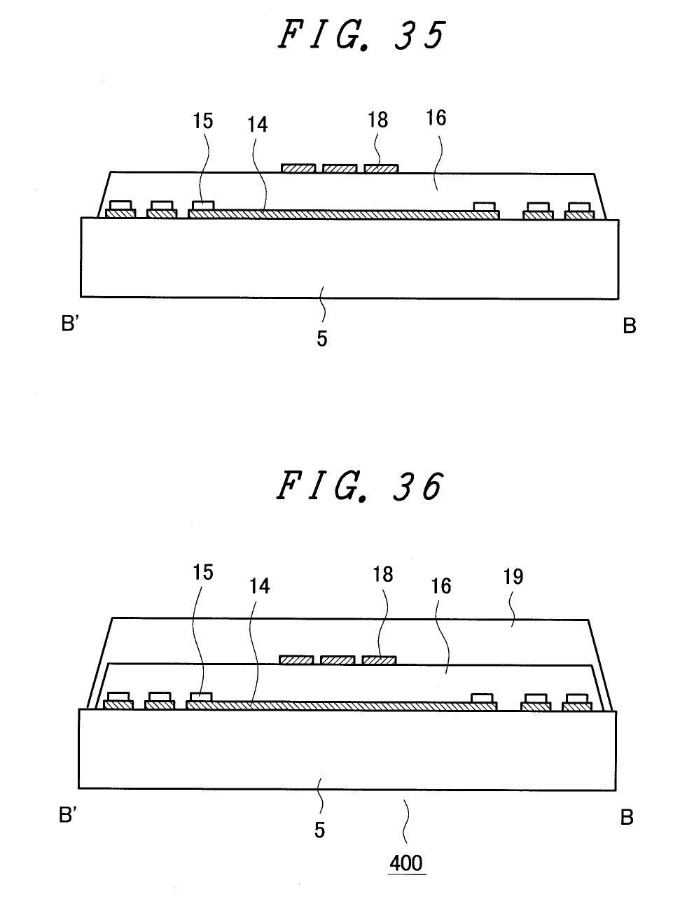

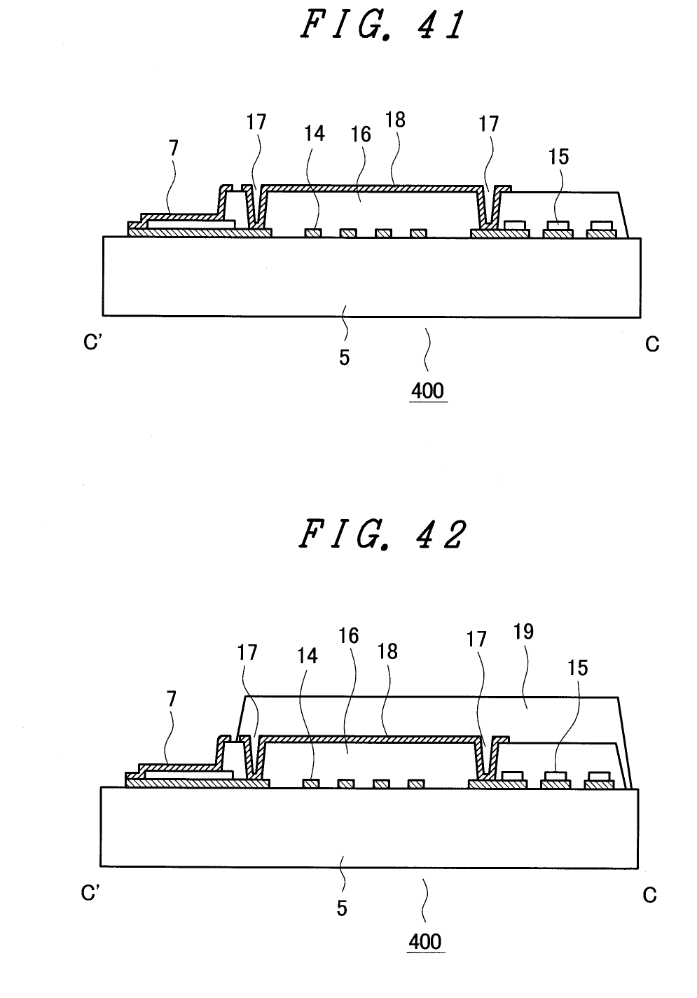

Next, with reference to FIGS. 35 and 41, a third step will be described. A second ITO film 18 is deposited to a thickness of about 30 nm; a resist film pattern is formed by a photolithography process; and the second ITO film 18 is patterned. Thereafter, the resist film is removed to form the second ITO film 18 as shown in FIGS. 35 and 41. The electrodes of the XY-electrode substrate 405 can be formed of the second ITO film 18, and, for example, the Y-electrode YP described with reference to FIG. 2 can be formed using the second ITO film 18.

Next, with reference to FIGS. 36 and 42, a fourth step will be described. The same film as the insulating film used in the second step is applied again on the substrate as the second insulating film 19. The pattern of the second insulating film 19 is formed by a photolithography process.

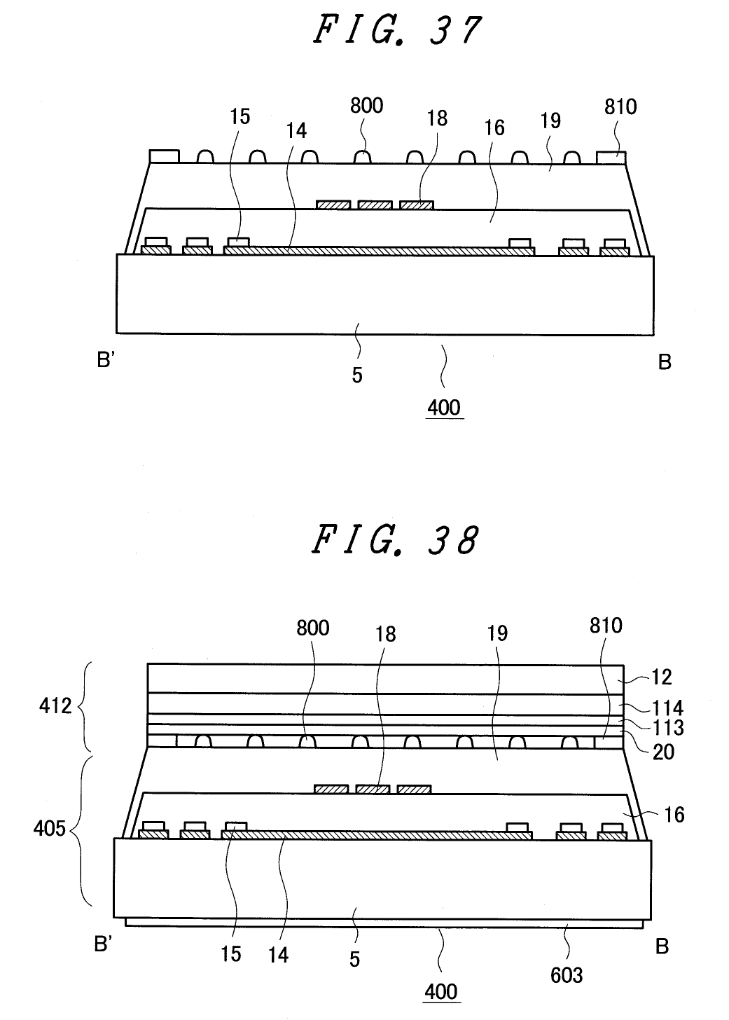

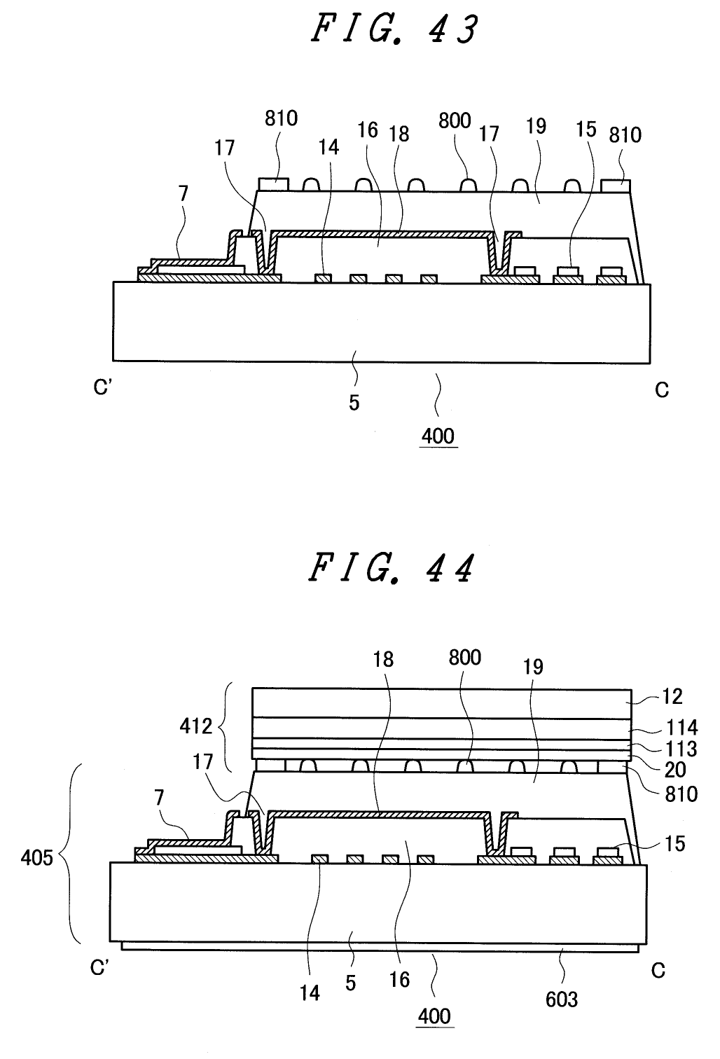

Next, with reference to FIGS. 37 and 43, a fifth step will be described. The spacers 800 are formed on the second insulating film 19 by a photolithography process. Thereafter, the sealing material 810 is formed at the peripheral portion by screen printing. In this manner, the preparation of the XY-electrode substrate 405 is completed.

Next, as shown in FIGS. 38 and 44, the Z-electrode substrate 412 which is separately manufactured is overlapped with the XY-electrode substrate 405 and fixed thereto with the sealing material 810. Thereafter, an ITO film is formed as a transparent conductive film 603 on the back face of the substrate 5. At this time, a mask for protecting the front face and peripheral portion of the substrate 5 is formed. When ITO is deposited on the back face, there is a risk that ITO goes around the edge of the substrate to attach to the front side. Therefore, the peripheral portion of the substrate 5 on the front face has to be protected by a mask. The touch panel 400 is formed through the steps described above.

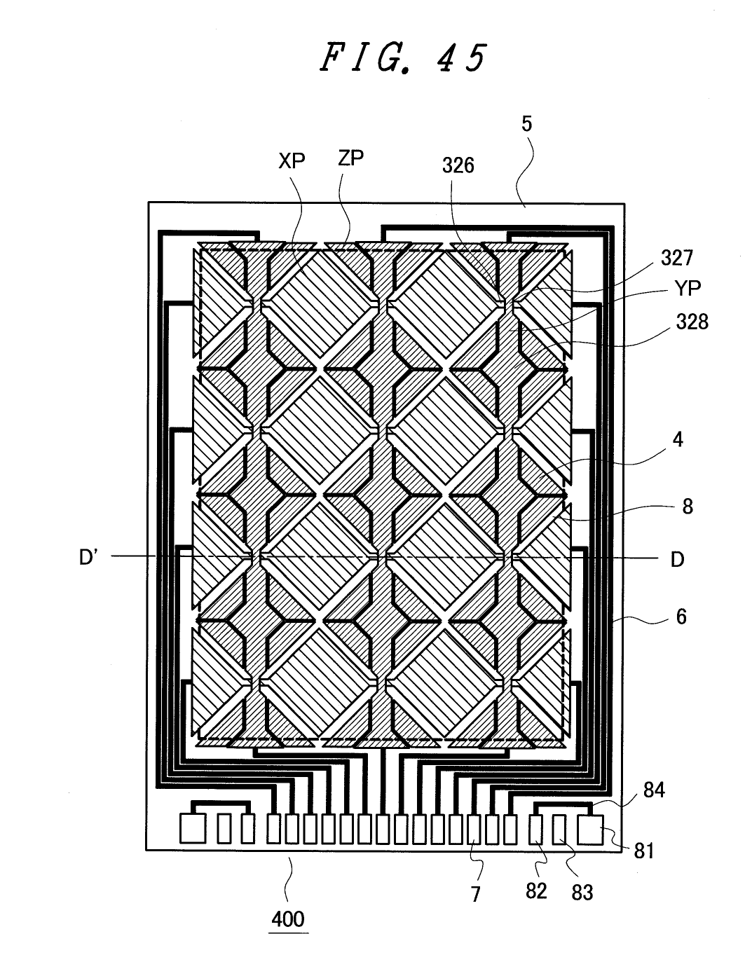

Next, with reference to FIG. 45, a modified example of the X-electrode XP and the Y-electrode YP will be described. In the touch panel 400 shown in FIG. 45, floating electrodes 4 are formed for making the respective total areas of the X-electrode XP and the Y-electrode YP equal. The difference in area between the X-electrode XP and the Y-electrode YP causes a problem in that the noise intensity is different between the X-electrode XP and the Y-electrode YP. Therefore, when the electrode of the Y-electrode YP having a great number of the individual electrodes 328 is made small, a gap 8 between the X-electrode XP and the Y-electrode YP is enlarged.

As described above, the Y-electrode YP and the X-electrode XP are formed of an ITO film (transparent conductive film). At the gap portion 8, however, an insulating film and a transparent substrate are formed, and the gap portion 8 is a region with no transparent conductive film. Since the difference in transmittance ratio, reflectance ratio, and chromaticity of reflected light is caused between a portion with a transparent conductive film and a portion with no transparent conductive film, the gap portion 8 is visible to the naked eye, decreasing quality of an image to be displayed.

As a result of our investigation, the gap is faintly visible when the gap portion 8 has a gap of 30 μm is almost invisible when 20 μm, and is invisible when 10 μm. As the gap portion 8 is narrowed, the capacitance between the Y-electrode YP and the X-electrode XP neighboring to each other via the floating electrode 4 is increased. Moreover, narrowing the gap portion 8 leads to an increases in failure of short-circuit between the Y-electrode YP or the X-electrode XP and the floating electrode 4 because of a pattern formation defect due to the attachment of a foreign substance, or the like during the steps.

When the floating electrode 4 neighboring to the individual electrode 328 of the Y-electrode YP is short-circuited, a grounded capacitance of one line of the relevant Y-electrode is increased to thereby increase noise, causing a disadvantage of decreasing detection sensitivity. For decreasing the capacitance to be increased when short-circuited, the floating electrode 4 is divided into four parts as shown in FIG. 45. When the electrode is divided into finer parts, the fear of the short-circuit failure is decreased. However, since the region with no transparent conductive film is increased in the relevant region, there is a fear of causing and increasing the difference in transmittance ratio, reflectance ratio, and chromaticity between the floating electrode 4 and the neighboring electrode. Therefore, the floating electrode 4 is divided into four parts as described above, and the electrode gap therebetween is set smaller than 30 around 20 μm.

In the touch panel 400 shown in FIG. 45, a different-layer intersecting portion 326 is disposed at the intersecting portion formed of the fine line portion 327. In the touch panel 400 shown in FIG. 45, the X-electrode XP and the Y-electrode YP are formed in the same layer, and the different-layer intersecting portion 326 is formed in a different layer from the X-electrode XP and the Y-electrode YP at the intersecting portion so that the electrodes intersect there.

In FIG. 45, the X-electrode XP and the Y-electrode YP are formed in a diamond shape so as to have a structure in which the electrode width is narrowed toward the intersecting portion, whereby the electrode width larger than the fine line portion 327 even a slight amount can be formed to the vicinity of the intersecting portion.

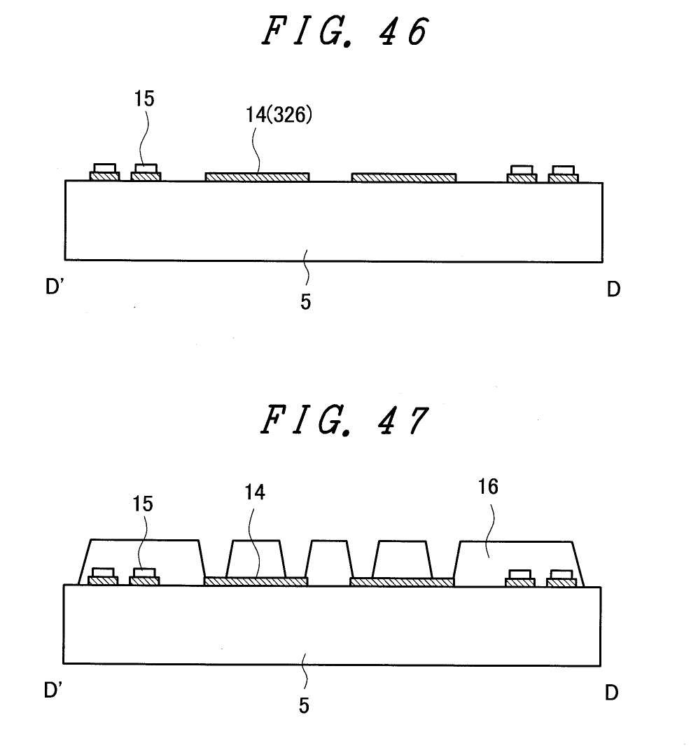

Hereinafter, with reference to FIGS. 46 to 51, a method for manufacturing the touch panel 400 shown in FIG. 45 is shown.

FIGS. 46 to 51 each show a cross-sectional view along the line D-D′ of FIG. 45, in which three X-electrodes XP are shown for avoiding complication of the drawing.

First, a first step will be described with reference to FIG. 46. In the step shown in FIG. 46, the first ITO film 14 (Indium Tin Oxide) is deposited to a thickness of about 15 nm on the transparent substrate 5 such as a glass substrate. Thereafter, the silver alloy film 15 is deposited to a thickness of about 200 nm. A resist film pattern is formed by a photolithography process, and the silver alloy film 15 is patterned.

After the resist film is removed; a next resist film pattern is formed by a photolithography process; and the first ITO film 14 is patterned. Thereafter, the resist film is removed, and patterns of the ITO film 14 and the silver alloy film 15 patterned as shown in FIG. 46 are formed. The first ITO film 14 shown in FIG. 46 forms the different-layer intersecting portion 326.

Next, with reference to FIG. 47, a second step will be described. On the substrate on which the patterns of the first ITO film 14 and the silver alloy film 15 are formed, the first insulating film 16 is applied and processed by patterning using a photolithography technique. For the first insulating film 16, a film containing SiO₂ as a main component is desirably applied to a thickness of 1 μm or greater.

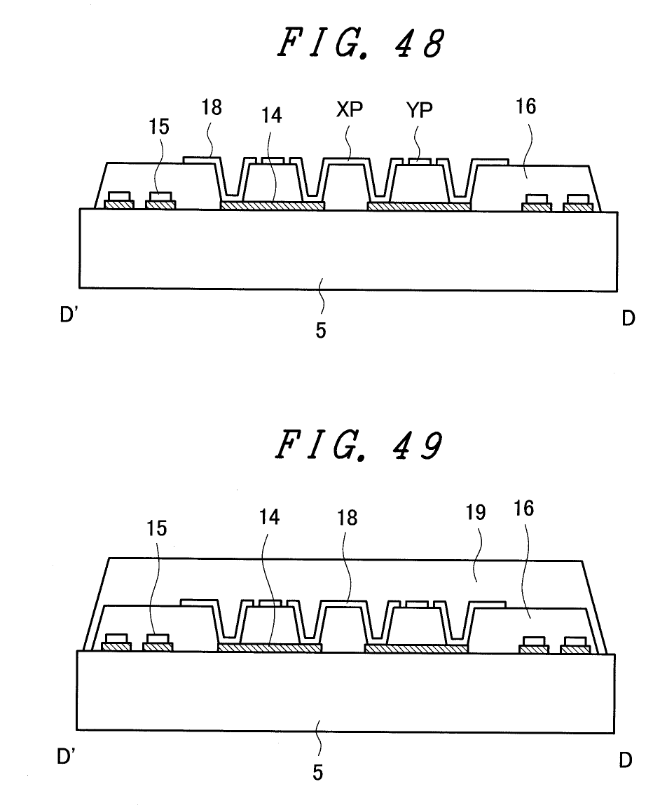

Next, with reference to FIG. 48, a third step will be described. The second ITO film 18 is deposited to a thickness of about 30 nm; a resist film pattern is formed by a photolithography process; and the second ITO film 18 is patterned. Thereafter, the resist film is removed, and the second ITO film 18 is formed as shown in FIG. 48. In the second ITO film 18, the X-electrode XP and the Y-electrode YP are formed in the same layer.

Next, with reference to FIG. 49, a fourth step will be described. The same film as the insulating film used in the second step is applied again on the substrate as the second insulating film 19. A pattern is formed on the second insulating film 19 by a photolithography process.

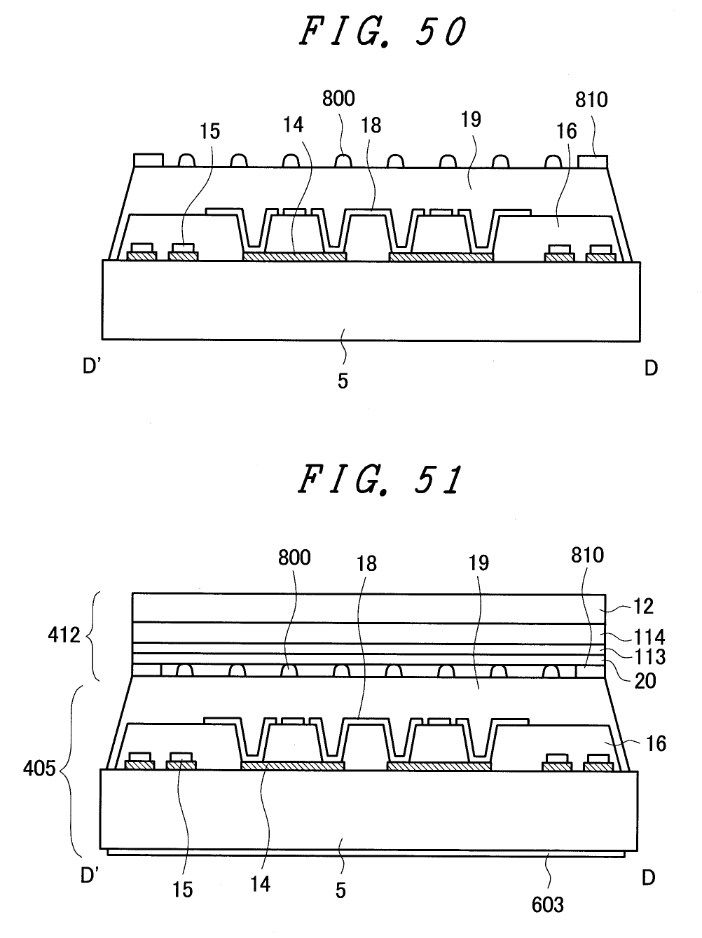

Next, with reference to FIG. 50, a fifth step will be described. The spacers 800 are formed on the second insulating film 19 by a photolithography process. Thereafter, the sealing material 810 is formed at the peripheral portion by screen printing. In this manner, the preparation of the XY-electrode substrate 405 is completed.

Next, as shown in FIG. 51, the Z-electrode substrate 412 which is separately manufactured is overlapped with the XY-electrode substrate 405 and fixed thereto with the sealing material 810. Thereafter, an ITO film is formed as the transparent conductive film 603 on the back face of the substrate 5. At this time, a mask for protecting the front face and peripheral portion of the substrate 5 is formed. When ITO is deposited on the back face, there is a risk that ITO goes around the edge of the substrate to attach to the front side. Therefore, the peripheral portion of the substrate 5 on the front face has to be protected by a mask. The touch panel 400 is formed through the steps described above.

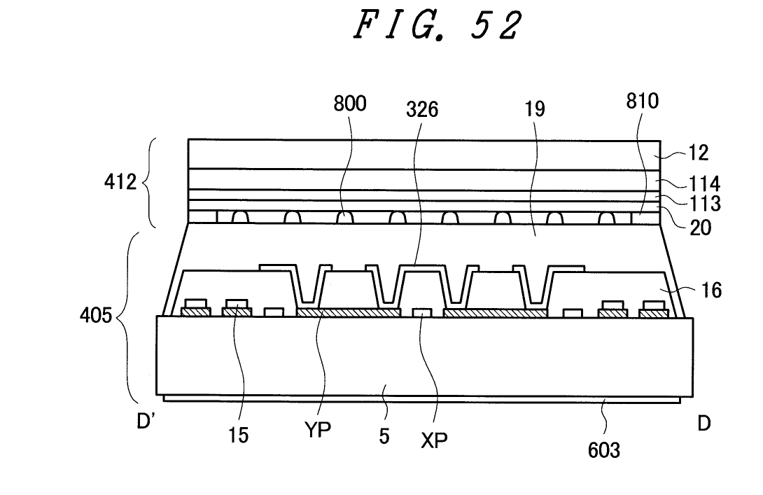

FIG. 52 is a schematic cross-sectional view in which the X-electrode XP and the Y-electrode YP are formed of the first ITO film in the same layer, and the different-layer intersecting portion 326 is formed of the second ITO film. The configuration of disposing the different-layer intersecting portion 326 is also applicable to the touch panel 400 shown in FIG. 32. The configuration can be realized by forming one of the electrodes with the different-layer intersecting portion 326 at the intersecting portion.

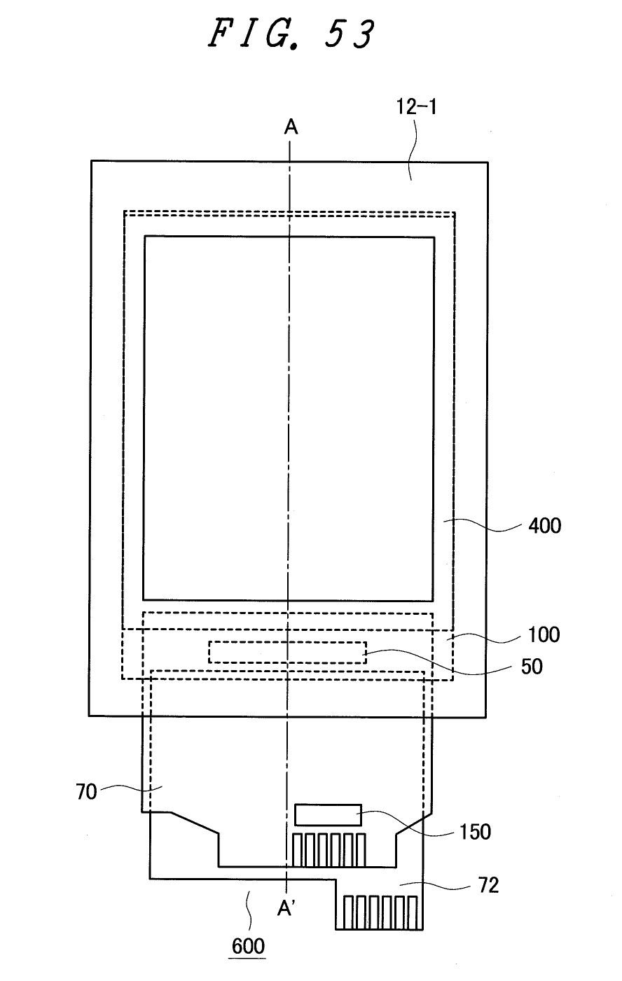

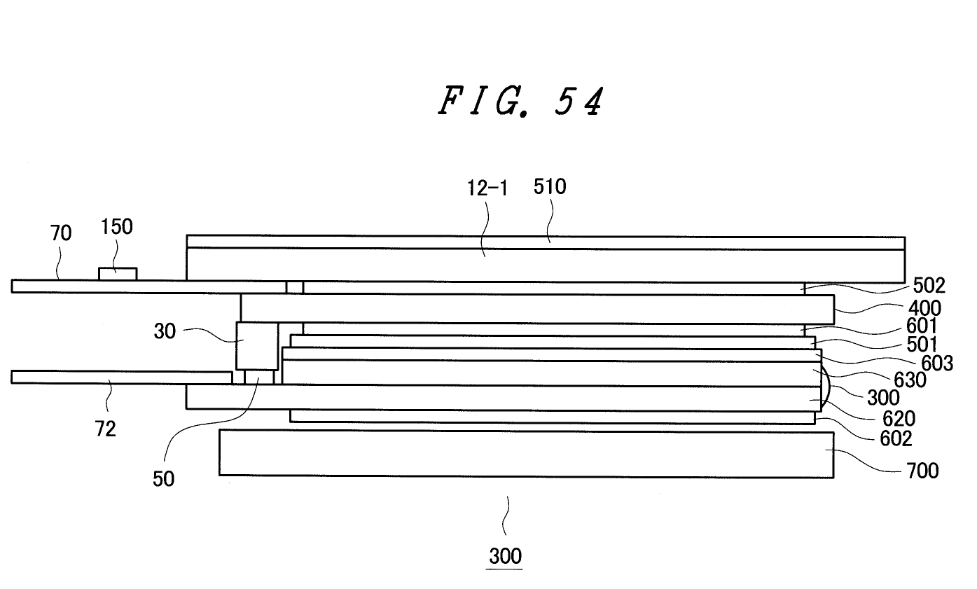

FIG. 53 is a schematic plan view in which the touch panel 400 is attached to a liquid crystal display panel 100 as an example of the display device 600 with a touch panel. FIG. 54 is a schematic cross-sectional view along the cutting line A-A′ of FIG. 53. Any of display panels may be used so long as it can use a touch panel. Without limiting to a liquid crystal display panel, an organic light emitting diode element or a surface-conduction electron-emitter can also be used.

As shown in FIGS. 53 and 54, the display device 600 of the embodiment includes the liquid crystal display panel 100, the capacitive touch panel 400 disposed on the face of the liquid crystal display panel 100 on the viewer side, and a backlight 700 disposed below the face of the liquid crystal display panel 100 on the side opposite from the viewer side. As the liquid crystal display panel 100, for example, a liquid crystal display panel of the IPS type, TN type, VA type, or the like is used.

The liquid crystal display panel 100 is formed by bonding two substrates 620 and 630 which are arranged to face each other. Polarizers 601 and 602 are respectively disposed on the outer surfaces of the two substrates. The liquid crystal display panel 100 and the touch panel 400 are adhered to each other with a first adhesive material 501 formed of a resin, an adhesive film, or the like. Further, a front face protective plate (also referred to as a front window or a front face panel) 12-1 formed of an acrylic resin is adhered to the outer surface of the touch panel 400 with a second adhesive material 502 formed of a resin, an adhesive film, or the like. The front face protective plate 12-1 corresponds to the second transparent substrate 12 shown in FIG. 3.

The transparent conductive layer 603 is disposed on the liquid crystal display panel side of the touch panel 400. The transparent conductive layer 603 is formed for purposes of shielding the touch panel from signals generated in the liquid crystal display panel 100.

A great number of electrodes are disposed in the liquid crystal display panel 100, and voltage is applied as signals on the electrodes at various timings. These changes in voltage in the liquid crystal display panel 100 appear as noise relative to the electrodes disposed in the capacitive touch panel 400.

Therefore, the touch panel 400 has to be electrically shielded from the liquid crystal display panel 100, so that the transparent conductive layer 603 is disposed as a shield electrode. A constant voltage is supplied from the flexible printed board 70 or the like to the transparent conductive layer 603 so that the transparent conductive layer 603 functions as a shield electrode. For example, the constant voltage is set to the ground potential.

The flexible printed board 70 is connected to the connection terminals 7 (not shown) formed on the face of the touch panel 400 where the electrodes are formed (hereinafter referred to as a front face), and the conductive member 80 is disposed for supplying voltage such as the ground potential to the face where the transparent conductive layer 603 is disposed (hereinafter referred to as a back face).

The transparent conductive layer 603 desirably has a sheet resistance value of from 1.5×10² to 1.0×10³ Ω/□ which is similar to that of the electrode disposed in the touch panel 400, for reducing the influence of noise. It is known that the resistance value of the transparent conductive layer 603 relates to the size of crystal grain. By setting the heat treatment temperature when forming the transparent conductive layer 603 at 200° C. or higher for promoting crystallization, the sheet resistance value can be set to from 1.5×10² to 1.0×10³ Ω/□.

The transparent conductive layer 603 can have a lower resistance. For example, by setting the heat treatment temperature at 450° C. and sufficiently performing the crystallization of the transparent conductive layer 603, the sheet resistance value can be set to from 30 to 40 Ω/□. When the transparent conductive layer 603 for shielding has a similar resistance or lower resistance compared to the electrode disposed in the touch panel 400, an effect of reducing noise is improved.

The drive circuit 150 is mounted on the flexible printed board 70. The detection of an input position or the like is controlled by the drive circuit 150. The electrodes disposed on the front face of the touch panel 400 and the drive circuit 150 are electrically connected via the flexible printed board 70.

A given voltage such as the ground potential is supplied to the transparent conductive layer 603 disposed on the back face via the flexible printed board 70.

Since the flexible printed board 70 is connected to the connection terminals 7 disposed on the front face of the touch panel 400, wiring lines have to be disposed from the connection terminals 7 so as to be electrically connected to the transparent conductive layer 603 disposed on the back face. Therefore, the back face connection pads 81 are disposed in alignment with the connection terminals 7, and the back face connection pads 81 and the transparent conductive layer 603 on the back face are connected with the conductive member 80.

In FIG. 54, a spacer 30 is inserted between the substrate 620 and the touch panel 400. In a hybrid structure combining the liquid crystal display panel 100 with the touch panel 400 and the front window 12-1, there arises a problem in that the strength of glass of the substrate 620 of the liquid crystal display panel 100 is low.

A region of the substrate 620 on which a liquid crystal drive circuit 50 is mounted protrudes from the other substrate 630, and has a one-plate shape. In the mounting region of the liquid crystal drive circuit 50, there arises a disadvantage of breaking the substrate 620 in some cases.

Therefore, the spacer 30 is inserted between the substrate 620 and the touch panel 400 to improve the strength. In FIG. 54, a protective sheet 510 is disposed on the front face of the front face protective plate 12-1, so that the front face protective plate 12-1 is prevented from being damaged by the pen 850.

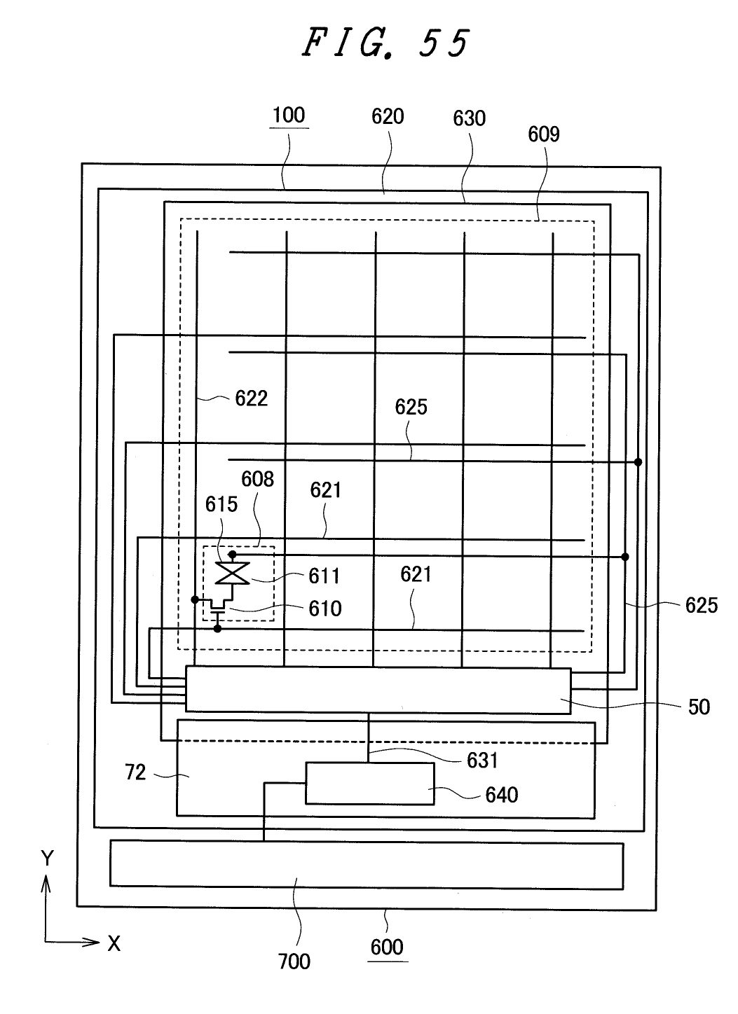

Next, with reference to FIG. 55, the liquid crystal display panel 100 will be described. FIG. 55 is a schematic plan view showing the basic configuration of the liquid crystal display panel 100. For describing the liquid crystal display panel 100, the touch panel 400 is omitted from the illustration. As described above, the liquid crystal display device is configured of the liquid crystal display panel 100, the liquid crystal drive circuit 50, a flexible board 72, and the backlight 700. On one side of the liquid crystal display panel 100, the liquid crystal drive circuit 50 is disposed. Various signals are supplied from the liquid crystal drive circuit 50 to the liquid crystal display panel 100. The flexible printed board 72 is electrically connected to the liquid crystal drive circuit 50 for supplying signals from the outside.

The liquid crystal display panel 100 is configured as follows: the substrate 620 (hereinafter also referred to as a TFT substrate) on which thin film transistors 610, pixel electrodes 611, counter electrodes (common electrodes) 615, and the like are formed and the substrate 630 (hereinafter also referred to as a filter substrate) on which color filters and the like are formed are overlapped with each other with a predetermined gap; both substrates are bonded together with a sealing material (not shown) disposed in a frame shape in the vicinity of the peripheral portion between the substrates; a liquid crystal composition is filled and sealed inside the sealing material; the polarizers 601 and 602 (refer to FIG. 2) are respectively attached to the outer surfaces of the substrates; and the flexible board 72 is connected to the TFT substrate 620.

The embodiment is applicable to a so-called lateral electric field type liquid crystal display panel in which the counter electrode 615 is disposed on the TFT substrate 620 and to a so-called vertical electric field type liquid crystal display panel in which the counter electrode 615 is disposed on the filter substrate 630, both in the same manner.

In FIG. 55, scanning signal lines (also referred to as gate signal lines) 621 extending in the x-direction in the drawing and arranged in parallel in the y-direction and video signal lines (also referred to as drain signal lines) 622 extending in the y-direction and arranged in parallel in the x-direction are disposed, and a pixel portion 608 is formed in each region surrounded by the scanning signal lines 621 and the drain signal lines 622.

Although the liquid crystal display panel 100 includes a great number of the pixel portions 608 arranged in a matrix, only one pixel portion 608 is shown in FIG. 55 for clarity of the drawing. The pixel portions 608 arranged in a matrix form a display region 609. Each of the pixel portions 608 functions as a pixel of a display image to display an image in the display region 609.

The thin film transistor 610 of each of the pixel portions 608 has a source connected to the pixel electrode 611, a drain connected to the video signal line 622, and a gate connected to the scanning signal line 621. The thin film transistor 610 functions as a switch for supplying a display voltage (gray scale voltage) to the pixel electrode 611.

Although the naming of “source” and “drain” may be reversed depending on the bias relationship, the electrode which is connected to the video signal line 622 is herein referred to as the drain. The pixel electrode 611 and the counter electrode 615 form a capacitance (liquid crystal capacitance).

The liquid crystal drive circuit 50 is arranged on a transparent insulating substrate (a glass substrate, a resin substrate, etc.) constituting the TFT substrate 620. The liquid crystal drive circuit 50 is connected to the scanning signal lines 621, the video signal lines 622, and counter electrode signal lines 625.

The flexible printed board 72 is connected to the TFT substrate 620. A connector 640 is disposed on the flexible printed board 72. The connector 640 is connected to an external signal line, so that signals from the outside are input thereto. A wiring line 631 is disposed between the connector 640 and the liquid crystal drive circuit 50, so that the signals from the outside are input to the liquid crystal drive circuit 50.

The flexible printed board 72 supplies a constant voltage to the backlight 700. The backlight 700 is used as a light source of the liquid crystal display panel 100. Although the backlight 700 is disposed on the back or front side of the liquid crystal display panel 100, the backlight 700 and the liquid crystal display panel 100 are illustrated side by side in FIG. 55 for simplifying the drawing.

The liquid crystal drive circuit 50 outputs a gray scale voltage corresponding to a gray scale to be displayed by a pixel to the video signal line 622. When the thin film transistor 610 is brought into the on state (conductive), a gray scale voltage (video signal) is supplied from the video signal line 622 to the pixel electrode 611. Thereafter, the thin film transistor 610 is brought into the off state, so that the gray scale voltage based on a video to be displayed by a pixel is held in the pixel electrode 611.

A constant counter electrode voltage is applied to the counter electrode 615. The liquid crystal display panel 100 changes the orientation direction of liquid crystal molecules interposed between the pixel electrode 611 and the counter electrode 615 with the potential difference therebetween and changes the light transmittance ratio or reflectance ratio to display an image.

As described above, the change in signals for driving the liquid crystal display panel 100 is detected as noise for the touch panel 400. Accordingly, countermeasures against it are required. Especially the touch panel 400 has a feature in that it prompts a user to input based on an image displayed on the liquid crystal display panel 100, and the touch panel has to be disposed so as to overlap a display device such as the liquid crystal display panel 100. Therefore, the touch panel is strongly affected by noise caused by the display device which is closely overlapped.

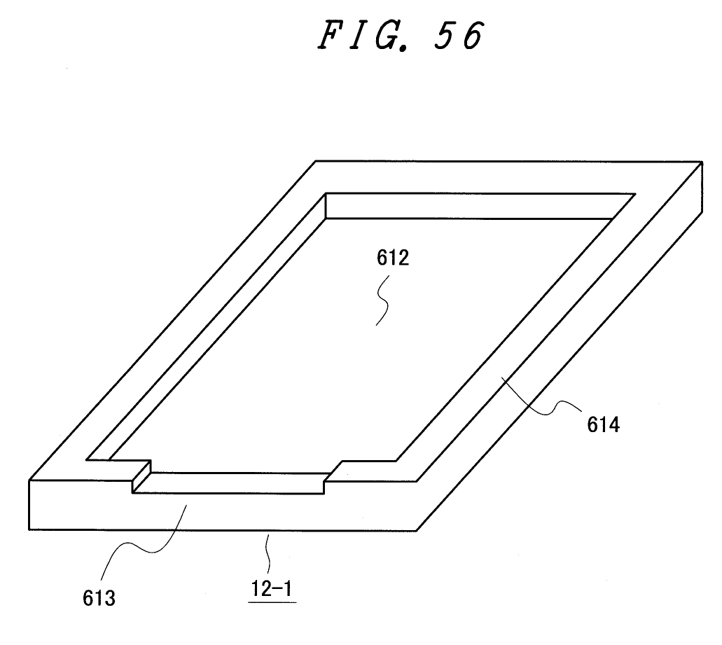

Next, with reference to FIG. 56, the front window 12-1 will be described. FIG. 56 is a schematic perspective view of the front window 12-1 as viewed from the touch panel 400 side. A recess 612 is formed in the front window 12-1, and the touch panel 400 can be contained therein. A peripheral portion 614 is formed thicker than the recess 612, whereby a sufficient strength is ensured at the peripheral portion 614. A groove 613 is formed in a part of the peripheral portion 614, so that the flexible printed board 70 can extend from the recess 612 to the outside.

The recess 612 disposed in the front face panel 12-1 can be formed by scraping the front window 12-1. The greater the thickness of the peripheral portion 614 of the front window 12-1 to be fixed to a housing or the like is, the greater the strength thereof is when the device falls down or the like. The thickness is desirably from 0.7 mm to 1.0 mm in a case of acrylic and from 0.5 mm to 1.0 mm in a case of glass.

However, since the great thickness of an object attached on the operation surface decreases sensitivity at the time of operation with a finger, a small thickness is desirable for the touch panel 400. Therefore, the thickness of the recess 612 is desirably from 0.5 mm or less in a case of acrylic and from 0.8 mm or less in a case of glass.

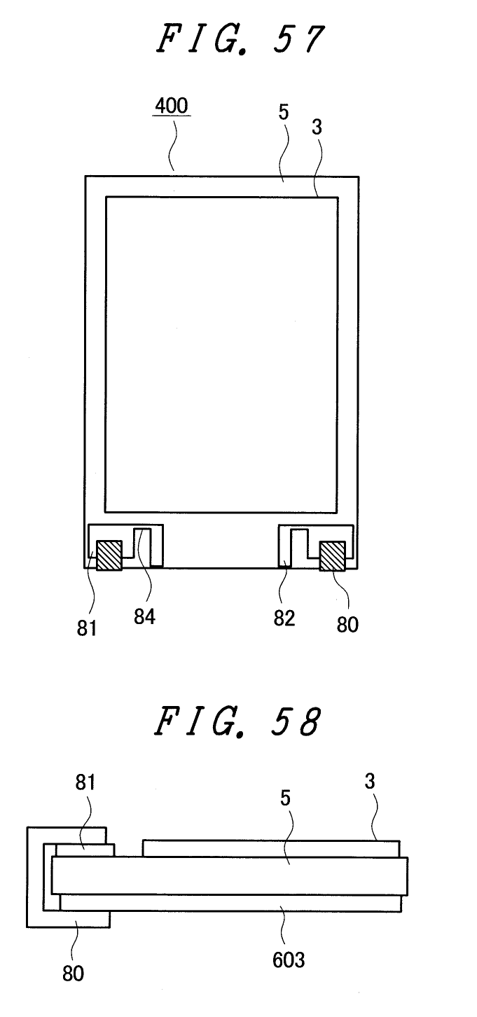

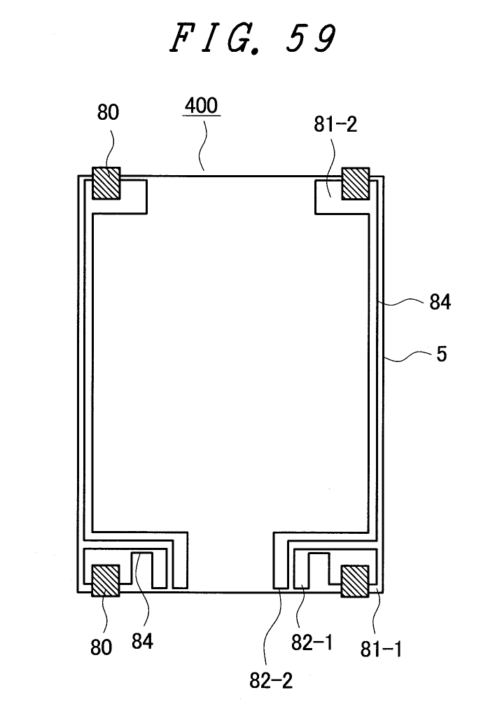

Next, FIGS. 57 and 58 show a state of connecting the transparent conductive layer 603 with the back face connection pad 81. FIG. 57 is a schematic plan view of the touch panel 400; and FIG. 58 is a schematic side view thereof. The illustration in FIG. 57 is simplified for describing the connection between the transparent conductive layer 603 and the back face connection pad 81. For the touch panel 400, an input region 3 is formed on the front face of the glass substrate 5.

The connection terminal 82 for the back face is formed on the front face, and the connection terminal 82 for the back face is connected to the flexible printed board 70 which is not shown. The connection terminal 82 for the back face and the back face connection pad 81 are connected via the wiring line 84. The wiring line 84 is formed integrally with the connection terminal 82 for the back face and the back face connection pad 81.

The back face connection pad 81 and the transparent conductive layer 603 are connected via a conductive tape (hereinafter, also the conductive tape is indicated by the reference numeral 80) as the conductive member 80. The conductive tape 80 has a wiring line formed of copper foil in a resinous base material, and an anisotropic conductive film including conductive beads each having a particle diameter of 4 μm is attached on one side of the copper foil. The conductive tape 80 is attached at one end to the back face connection pad 81 and at the other end to the transparent conductive layer 603. After the attachment, the conductive tape 80 is thermocompression-bonded by a tweezers-type thermocompression-bonding jig. In FIG. 57, the conductive tape 80 is connected at two, right and left locations at the edge of the touch panel 400 on the side where the connection terminals 7 are disposed.

Using the conductive tape 80 which is more inexpensive than a flexible printed board and performing thermocompression-bonding by a tweezers-type thermocompression-bonding jig which is a general tool enables a reduction in cost. Work with a tweezers-type thermocompression-bonding jig eliminates the need to turn over the touch panel 400 upon thermocompression-bonding on the back face, which reduces the possible damage or contamination to the electrode surface of the touch panel 400.

FIG. 59 shows the touch panel 400 in which back face connection pads 81-2 are disposed at an edge of the touch panel 400 opposite from the side where the connection terminals 7 are disposed and connected with the wiring pattern 84 above the glass substrate 5. A transparent conductive film has a higher specific resistance than general metals. In FIG. 59, therefore, the back face connection pad is disposed at each of four corner portions of the substrate, or the back face connection pad 81-2 additionally is disposed at the edge opposite from the edge where the connection terminals 7 are disposed, whereby the potential of the transparent conductive layer 603 on the back face can be unified.

In FIG. 59, a connection terminal 82-1 for the back face relative to a back face connection pad 81-1 at the corner portion at the edge on the side where the connection terminals 7 are disposed and a connection terminal 82-2 for the back face relative to the back face connection pad 81-2 at the opposite edge from the side where the connection terminals 7 are disposed are separately illustrated. However, even when they are connected with the wiring pattern 84 above the glass, the same effect can be provided. The wiring pattern 84 is formed of a multilayer of a transparent conductive film and a metal film to lower its wiring resistance than in a case of forming with one layer of a transparent conductive film.

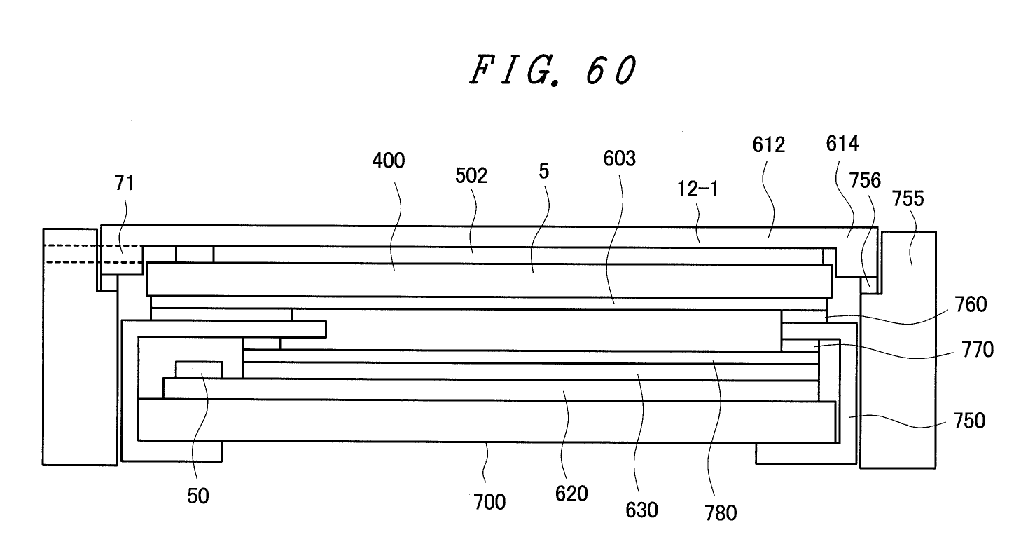

Next, FIG. 60 shows a state where the touch panel 400 is stacked with the display device using a metal frame 750, and the front face panel 12-1 is adhesively fixed to a mold frame 755. The transparent conductive layer 603 disposed on the back face of the touch panel 400 and the metal frame are connected with an anisotropic conductive tape 760 using a conductive resin or conductive beads. Application of voltage signal to the transparent conductive layer 603 on the back face of the touch panel 400 is performed via the metal frame 750 of the display device. Therefore, without using a dedicated pattern or member connecting between the front and back of the touch panel, voltage can be applied to the transparent conductive layer 603. The same effect can be provided even when the transparent conductive layer 603 is connected, instead of the metal frame 750, to the connection pad on the substrate of the display device or the pattern on the flexible printed board on the display device side with a conductive resin or the like.

Reference numeral 780 denotes a transparent conductive layer formed on the liquid crystal display panel side, and the transparent conductive layer is connected to the metal frame 750 with a conductive resin 770 or the like. The transparent conductive layer 603 is disposed on the back face of the touch panel 400, and further, the transparent conductive layer 780 is disposed on the liquid crystal display panel side, whereby a shield effect is improved.

The mold frame 755 is disposed so as to surround the outer circumference of the metal frame 750. The peripheral portion 614 of the front face panel 12-1 is fixed to the mold frame 755 with an adhesive material 756 such as a pressure-sensitive adhesive double-coated tape. The peripheral portion 614 is formed thick compared to the recess 612, so that the strength is maintained in terms of fixation.

According to the embodiment of the invention as described above, even when nonconductive input means contacts the touch panel, the distance between the X-electrode XP or the Y-electrode YP for capacitance detection and the Z-electrode ZP above the X-electrode XP or the Y-electrode YP changes to thereby cause a capacitance change. Therefore, input coordinates can be detected as a capacitive coupling system. This makes it possible to coop with a resin-made stylus having low conductivity.

The electrode shape is devised so that an input position between X-electrodes neighboring to each other can be calculated based on the signal ratio of capacitance changes obtained from the two neighboring X-electrodes, whereby the number of X-electrodes is decreased. Moreover, the number of Y-electrodes can be decreased by devising the arrangement of the Z-electrode. This makes it possible to narrow a frame width necessary for wiring lines drawn from the detecting electrodes to the input processing unit, improving the design degree of freedom. Moreover, since an increase in the number of terminals in the input processing unit can be suppressed, a capacitive coupling touch panel which enables highly accurate input position detection can be realized at low cost. Further, since input coordinates can be detected with good accuracy even with input means having a small contact surface, for example, a stylus, application use such as character input is also possible.

Moreover, one of the X-electrode XP and the Y-electrode YP is sequentially applied with a pulse signal to previously determine from which electrodes the signal is output, so that detection can be performed with good accuracy even when two points are contacted simultaneously.

Although the invention made by the present inventors has been specifically described based on the embodiment, the invention is not limited to the embodiment and can be of course modified variously without departing from the gist thereof.

What is claimed is:

1. A display device comprising:
a capacitive touch panel,
the capacitive touch panel including a plurality of X-electrodes, a plurality of Y-electrodes, and a Z-electrode,
the X-electrode and the Y-electrode intersecting with each other via a first insulating layer at an intersecting portion, each of the X-electrode and the Y-electrode being formed such that pad portions and fine line portions are alternately arranged in its extending direction, the pad portion of the X-electrode and the pad portion of the Y-electrode being arranged so as not to overlap each other as viewed in plan,
the Z-electrode being formed so as to overlap, via a second insulating layer, both the X-electrode and the Y-electrode neighboring to each other as viewed in plan,
the Z-electrode being electrically floating,
one of the X-electrode and the Y-electrode being sequentially applied with a pulse signal, and a change in the signal being detected from the other electrode, wherein
the Z-electrode is formed of an elastic conductive material, and
the intersecting portion is formed in a different layer from the X-electrode or the Y-electrode.

2. The display device according to claim 1, wherein
the second insulating layer changes in thickness by pressing.

3. The display device according to claim 1, wherein
a thickness of the second insulating layer is maintained with a spacer.

4. The display device according to claim 1, wherein
the pad portion of the X-electrode extends to the vicinities of fine line portions of X-electrodes neighboring to the relevant X-electrode,
the relevant X-electrode has a shape in the pad portion such that, as viewed in plan, an area is minimized in the vicinity of the fine line portion of one of the neighboring X-electrodes and maximized in the vicinity of the fine line portion of the relevant X-electrode, and
the area of the relevant pad portion decreases from the vicinity of the fine line portion of the relevant X-electrode toward the vicinity of the fine line portion of the other neighboring X-electrode.

5. The display device according to claim 1, wherein
the pad portion of the X-electrode extends to the vicinities of fine line portions of X-electrodes neighboring to the relevant X-electrode,
the pad portion of the relevant X-electrode has a shape such that, as viewed in plan, an electrode width is minimized in both the vicinities of the fine line portions of the neighboring X-electrodes and maximized in the vicinity of the fine line portion of the relevant X-electrode,
the pad portion of the Y-electrode has a shape such that, as viewed in plan, a width in an extending direction of the X-electrode is constant relative to an extending direction of the Y-electrode, and
the pad portions of the X-electrode and the pad portions of the Y-electrode are alternately arranged in the extending direction of the X-electrode as viewed in plan.

6. The display device according to claim 1, wherein
in the pad portions of the two neighboring X-electrodes, the pad portion has a convex shape toward the neighboring X-electrode.

7. The display device according to claim 1, wherein
in the pad portions of the three neighboring X-electrodes, the pad portion has a convex shape toward one of the neighboring X-electrodes and has a concave shape toward the other X-electrode.

8. The display device according to claim 1, wherein
the Z-electrode is stacked with an elastic insulating film.

9. The display device according to claim 1, wherein
the Z-electrode is stacked on a supporting layer.

10. A display device comprising:
a capacitive touch panel which detects touch position coordinates on a display region by a capacitive system,
the capacitive touch panel including a plurality of X-electrodes, a plurality of Y-electrodes, and a Z-electrode,
the X-electrode and the Y-electrode intersecting with each other via a first insulating layer at an intersecting portion, each of the X-electrode and the Y-electrode being formed such that pad portions and fine line portions are alternately arranged in its extending direction, the pads portion of the X-electrode and the pad portions of the Y-electrode being arranged so as not to overlap each other as viewed in plan,
the Z-electrode being formed so as to overlap, via a second insulating layer, both the plurality of X-electrodes and the plurality of Y-electrodes as viewed in plan,
the Z-electrode being electrically floating,
one of the X-electrode and the Y-electrode being sequentially applied with a pulse signal, and a change in the signal being detected from the other electrode, wherein
the Z-electrode is formed of an elastic conductive material, and
the intersecting portion is formed in a different layer from the X-electrode or the Y-electrode.

11. The display device according to claim 10, wherein
the Z-electrode is stacked with an elastic insulating film.

12. The display device according to claim 10, wherein
the Z-electrode is a solid electrode.

13. A display device comprising:
a capacitive touch panel which detects touch position coordinates on a display region by a capacitive system,
the capacitive touch panel including a plurality of X-electrodes, a plurality of Y-electrodes, and a Z-electrode,
the X-electrode and the Y-electrode intersecting with each other via a first insulating layer at an intersecting portion, each of the X-electrode and the Y-electrode being formed such that individual electrodes and the intersecting portions are alternately arranged in its extending direction, the individual electrode of the X-electrode and the individual electrode of the Y-electrode being arranged without overlapping each other as viewed in plan,
the Z-electrode being formed so as to overlap, via a second insulating layer, both the X-electrode and the Y-electrode as viewed in plan,
the Z-electrode being electrically floating,
the second insulating layer being formed of a gas whose volume changes by pressure,
one of the X-electrode and the Y-electrode being sequentially applied with a pulse signal, and a change in the signal being detected from the other electrode, wherein
the Z-electrode is formed of an elastic material, and
the intersecting portion is formed in a different layer from the X-electrode or the Y-electrode.

14. The display device according to claim 13, wherein
the second insulating layer is air.
